(19) United States
(12) Patent Application Publication
(10) Pub. No.: US 2008/0273698 A1
(43) Pub. Date: Nov. 6, 2008

(54) Device for and a Method of Processing a Data Stream Having a Sequence of Packets and Timing Information Related to the Packets

(75) Inventors: Roland Manders, Horst (NL); Eric Moors, Someren (NL); Albert Rijckaert, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/912,316

(22) PCT Filed: Apr. 25, 2006
(86) PCT No.: PCT/IB06/51277

§ 371 Date: Oct. 23, 2007

(30) Foreign Application Priority Data
Apr. 26, 2005 (EP) 05103393.4

(51) Int. Cl. H04N 7/167

(52) U.S. Cl. 380/200

(57) ABSTRACT

A device (3400) for processing an encrypted data stream (3401), wherein the device (3400) comprises a decrypting unit (3402) for generating a decrypted data stream (3403) from the encrypted data stream (3401), a detecting unit (3404) for detecting position information of at least one intra-coded frame in the decrypted data stream (3403), and a replacement unit (3405) for replacing, based on the detected position information, portions of the encrypted data stream (3401) by corresponding portions of the decrypted data stream (3403).

### FIELD OF THE INVENTION

The invention relates to a device for processing an encrypted data stream.

Beyond this, the invention relates to a method of processing an encrypted data stream.

Moreover, the invention relates to a device for processing a data stream having a sequence of packets and timing information related to the packets.

The invention further relates to a method for processing a data stream having a sequence of packets and timing information related to the packets.

Moreover, the invention relates to a program element.

Furthermore, the invention relates to a computer-readable medium.

### BACKGROUND OF THE INVENTION

Electronic entertainment devices become more and more important. Particularly, an increasing number of users buy hard disk based audio/video players and other entertainment equipment.

Since the reduction of storage space is an important issue in the field of audio/video players, audio and video data are often stored in a compressed manner, and for security reasons in an encrypted manner.

MPEG2 is a standard for the generic coding of moving pictures and associated audio and creates a video stream out of frame data that can be arranged in a specified order called the GOP (“Group Of Pictures”) structure. An MPEG2 video bitstream is made up of a series of data frames encoding pictures. The three ways of encoding a picture are intra-coded (I picture), forward predictive (P picture) and bi-directional predictive (B picture). An intra-coded frame (I-frame) is related to a particular picture and contains the corresponding data. A forward predictive frame (P-frame) needs information of a preceding I-frame or P-frame. A bi-directional predictive frame (B-frame) is dependent on information of a preceding or subsequent I-frame or P-frame.

It is an interesting function in a media playback device to provide, in addition to a normal reproduction mode, in which media content is played back in a normal speed, a trick-play reproduction mode, in which media content is played back in a modified manner, for instance with an increased speed (“fast forward”).

However, for generating a trick-play stream it may be necessary to process the data in a complicated manner.

WO 03/107664 A1 discloses a method and an apparatus for processing a stream that contains encrypted information, wherein the starts and the ends of I-frames are detected. In response to the detection, it is controlled whether a corresponding packet is encrypted.

### OBJECT AND SUMMARY OF THE INVENTION

It is an object of the invention to process a data stream in an efficient manner.

In order to achieve the object defined above, a device for and a method of processing an encrypted data stream, a device for and a method of processing a data stream having a sequence of packets and timing information related to the packets, a program element and a computer-readable medium according to the independent claims are provided.

According to an exemplary embodiment of the invention, a device for processing an encrypted data stream is provided, wherein the device comprises a decrypting unit for generating a decrypted data stream from the encrypted data stream, a detecting unit for detecting position information of at least one intra-coded frame in the decrypted data stream, and a replacement unit for replacing, based on the detected position information, portions of the encrypted data stream by corresponding portions of the decrypted data stream.

According to another exemplary embodiment of the invention, a method of processing an encrypted data stream is provided, wherein the method comprises the steps of generating a decrypted data stream from the encrypted data stream, detecting position information of at least one intra-coded frame in the decrypted data stream, and replacing, based on the detected position information, portions of the encrypted data stream by corresponding portions of the decrypted data stream.

According to still another exemplary embodiment of the invention, a device for processing a data stream having a sequence of packets and timing information related to the packets is provided, wherein the device comprises a distribution unit for uniformly distributing the packets over the data stream, and a replacement unit for replacing the timing information of the data stream by modified timing information adjusted to the uniform distribution of the packets.

According to another exemplary embodiment of the invention, a method of processing a data stream having a sequence of packets and timing information related to the packets is provided, wherein the method comprises the steps of uniformly distributing the packets over the data stream, and replacing the timing information of the data stream by modified timing information adjusted to the uniform distribution of the packets.

Beyond this, according to another exemplary embodiment of the invention, a computer-readable medium is provided, in which a computer program is stored, which computer program, when being executed by a processor, is adapted to control or carry out any of the above-mentioned methods.

Moreover, according to still another exemplary embodiment of the invention, a program element is provided, which program element, when being executed by a processor, is adapted to control or carry out any of the above-mentioned methods.

The data processing according to the invention can be realized by a computer program, that is to say by software, or by using one or more special electronic optimization circuits, that is to say in hardware, or in hybrid form, that is to say by means of software components and hardware components.

The characterizing features according to the invention particularly have the advantage that the processing of a data stream can be performed in an efficient manner by replacing selectively only those data in a data stream that is required for the further use of the data stream. In other words, an existing data stream is modified only partially (and preferably as few as possible modifications are performed) so that the resulting data stream can be used as a basis for a particular target application, for instance trick-play generation. Thus, a common aspect of the embodiments of the invention is directed to the selective replacement of particular portions of a data stream.

According to one aspect of the invention, this is particularly realized by decrypting an encrypted data stream completely, by detecting I-frame positions in the fully decrypted data stream and by selectively replacing only those portions in the encrypted data stream, which portions relate to positions of I-frames. By taking this measure, it may be ensured that only those portions remain decrypted for which non-encrypted transmittal is absolutely necessary—particularly to allow that the processed data stream being a mixture of encrypted and decrypted parts may be used as a basis for trick-play generation. Thus, an efficient processing and a high level of security may be achieved simultaneously.

Therefore, in the case of an encrypted original normal play stream (particularly in the MPEG standard), a digital video broadcasting (DVB) encrypted trick-play stream may be generated even in a scenario in which the use of a DVB encryption engine (for instance at home) is not allowed.

According to an exemplary embodiment of this aspect of the invention, a method of generating a hybrid stream from an encrypted video transport stream consisting of data packets is provided, wherein first a decrypted transport stream of the encrypted video transport stream is generated. Then, I-frames may be detected in the decrypted transport stream, wherein pointers to the start and end of the I-frame(s) may be identified. Furthermore, at the positions of the pointers to the start and to the end of the I-frames, corresponding decrypted packets of the decrypted transport stream may replace the encrypted packets in the transport stream.

Thus, a hybrid transport stream (that is to say a basically encrypted transport stream with some packets in plaintext) may be generated. In this context, the packets of the transport stream that should be minimally in plaintext (to be able to generate a valid MPEG2 trick-play transport stream from this hybrid stream) may be generated or selected. Further, the detection of several important fields needed to construct a trick-play transport stream may be carried out. Therefore, a (DVB) encrypted trick-play stream can be generated even if the use of a (DVB) encryption engine at home is not allowed.

Exemplary application fields of the system according to the invention are digital video recording devices (such as HDD combinations, DVD+RW, etc.) and network enabled devices using trick-play.

According to the described aspect of the invention, a minimal amount of data that should be in plaintext of any frame (I-frame, P-frame or B-frame) can be estimated to allow the generation of an encrypted trick-play stream from it. Besides that, it is possible to decide which transport stream packets should be in plaintext, and which can stay encrypted. This decision and corresponding conversion (particularly decryption) is intended to be done either at the broadcasting end, or at the storage device receiving the stream.

Furthermore, it is possible according to the invention to detect the frame boundaries in this partially (but often almost completely) encrypted stream again at the receiver end when a trick-play stream is to be generated from this stream. This allows creating an encrypted trick-play stream. Therefore, an encrypted transport stream may be created, and for this purpose frame positions may be detected.

According to the described aspect of the invention, it is possible to start with an encrypted stream, and only those packets may be decrypted that need to be changed. They are usually not re-encrypted, particularly in a scenario in which an encrypter cannot be used. To perform this action, the stream may be first decrypted in order to find headers. In fact, the described aspect may use a plaintext and an encrypted stream as inputs. On the basis of the header detection, a selection may be made which input stream is passed on to the output. The whole processing may be performed inside a secure environment like inside an IC, such that the plaintext stream may be not accessible. This means that the system may have an encrypted input stream and a mostly encrypted output stream with some plaintext packets. In some cases, not all the packets containing header information may be in plaintext, because only those portions need to be in plaintext that shall be changed, and not necessarily the complete header. This is especially clear when, for instance, the picture start code is divided over two packets. In this case, part of the picture start code may still be encrypted. An algorithm may be provided to select the packets that need to be in plaintext. This algorithm can lead to partly encrypted picture start codes, but may minimize the memory demand. Putting the complete picture start code in plaintext would lead to the need of a larger buffer memory.

According to another aspect of the invention, a data stream having a sequence of packets and timing information related to these packets may be processed by smoothing or uniformly distributing packets of the data stream, and by replacing and updating timing information of the data stream by generating and incorporating timing information related to the smoothed data stream. However, replacing may be performed prior to distributing. By this substitution of parts of the data stream for compliance of a smoothed data stream with corresponding timing information requirements, a modified data stream is generated which may serve as part of the trick-play generation.

According to this aspect of the invention, a method of generating a trick-play stream from a video stream is provided, wherein the video stream may be composed of a Group Of Pictures (GOP) organized in packets, the packets being transmitted within a GOP time window. According to the described method, Program Clock Reference (PCR) packets may be calculated on basis of a packet time distance out of a total number of packets of a GOP and the GOP time window. Further, adding Program Clock Reference (PCR) packets at the start of each trick-play GOP may generate a time base for the trick-play stream.

If present, a Decoding Time Stamp (DTS) and/or a Presentation Time Stamp (PTS) may be adapted correspondingly with a time base.

In an exemplary case of an encrypted trick-play stream, Entitlement Control Messages (ECM) may be present in this trick-play stream to enable the decryption by a receiver (for instance a set-top box, STB). For instance, an ECM may be added to the end of a previous trick-play GOP of the trick-play stream.

According to the described aspect of the invention, a trick-play stream (encrypted or in plaintext, or being a mixture of both) on transport stream level can be handled by the same output circuitry as used for normal play (particularly without doing any re-multiplexing). Moreover, low processing resources may be sufficient to construct the trick-play on transport stream level. Furthermore, a trick-play method according to an exemplary embodiment of the invention can be used for transport streams with or without pre-pended packet arrival time stamps.

Thus, according to an exemplary embodiment of the present invention, trick-play stream construction on transport stream level is enabled without re-multiplexing. For this purpose, a trick-play stream may be generated out of a transport stream, wherein packets are smoothed over a trick-play stream GOP, the timing information may be replaced by a new time base information (for instance PTS, DTS, PCR), and Entitlement Control Messages (ECM) may be added to the encrypted trick-play stream (for example at the end of the trick-play GOP).

In the following, some further aspects according to an exemplary embodiment of the invention will be described.

Transport stream packets may be smoothed over one trick-play GOP (“TP GOP”). Further, a distance in a transmission time between TP GOPs may be constant and exactly equal to the total display time of the frames and the GOP. An additional PCR packet may be provided at the start of each GOP. The PES packet size may be equal to one TP GOP, which results in one DTS/PTS per TP GOP. Beyond this, the DTS may be equal to or larger than the PCR base of the next TP GOP. For instance, it may be equal to the PCR base of the next TP GOP. The PCR base of the next TP GOP may be equal to the PCR base of the current TP GOP plus a constant delta value. Beyond this, it may be exactly defined which ECM should be inserted at what point in the stream for improving or optimizing the performance. Depending on an SCB (Scrambling Control Bits) toggle, this position may be at TP GOP boundaries and sometimes within the I-frame data.

The selection of the distance in transmission time between TP GOPs to be constant and equal to the total display time of the frames in the GOP, and the provision of an additional PCR packet at the start of each TP GOP may lead to a simple mechanism for the generation of the PCRs because the PCR extension can be set to zero, omitting the need for a more complex modulo 300 calculation. Moreover, the difference between subsequent PCRs may be a fixed delta value, which delta value may further contribute to the simplification of the algorithm.

By providing the PES packet size equal to one TP GOP, and by providing the DTS to be equal or larger than the PCR base of a next TP GOP, a simple algorithm is obtained for the generation of the DTS values because the same fixed delta may be used as for the PCRs. In fact, the DTS may be equal to the PCR that has to be inserted in the next TP GOP. Or in other words, the PCR may be equal to the DTS of the previous TP GOP. This means that the calculation in fact only has to be performed once instead of twice.

The insertion of an ECM allows optimizing the structure of the modified data stream.

Further, it may be advantageous to construct an encrypted trick-play stream from an encrypted normal play stream. This may be particularly advantageous for fast forward or reverse, but even more for slow forward. Furthermore, it may be advantageous that the encryption method for the trick-play stream is identical to the one for normal play.

Referring to the dependent claims, further exemplary embodiments of the invention will be described.

Next, exemplary embodiments of the device for processing an encrypted data stream will be described. These embodiments may also be applied for the method of processing an encrypted data stream, for the computer-readable medium and for the program element.

The detecting unit may be adapted for detecting position information of at least one forward predictive frame (P-frame) and/or of at least one bi-directional predictive frame (B-frame) in the decrypted data stream. In other words, in addition or as an alternative to the detection of I-frame boundaries and to the replacement of corresponding encrypted portions of the data stream by decrypted portions, also P-frame and/or B-frame boundaries may be detected and replaced by corresponding decrypted portions. For several trick-play applications, it may be advantageous to find all frame boundaries.

The device may further be adapted to record a hybrid stream. A hybrid stream comprising original encrypted portions and modified decrypted portions may be stored in the device.

The detecting unit of the device may be adapted to detect, as position information, a start position and an end position of at least one intra-coded frame in the decrypted data stream. Only the start position and the end position of an I-frame has to be inserted in a decoded manner in the, apart from this, encrypted data stream. By taking this measure, the amount of decrypted data in the data stream may be minimized so that the security may be maximized.

The replacement unit may be adapted to replace portions of the encrypted data stream by corresponding portions of the decrypted data stream at the detected start position and end position of the at least one intra-coded frame in the decrypted data stream. Particularly, the main part of the I-frames may remain encrypted which allows a high degree of security.

Furthermore, an adding unit may be provided adapted to add timing information to a data stream which has already been processed before by the replacement unit. Since the old timing information relates to the original data stream, the transition to trick-play may have the consequence that the timing information may not be correct any longer for trick-play. For this purpose, the timing information may be updated in accordance with the modified data stream.

Particularly, the adding unit may be adapted to add the timing information in plaintext. Then, only the timing information and the starts and ends of the I-frames may be in plaintext, wherein the rest of the data stream may stay encrypted. The replacement unit may further be adapted to replace an amount of data of the encrypted data stream by corresponding portions of the decrypted data stream which amount is minimally required for generating a data stream for reproduction in a trick-play reproduction mode. By minimizing the amount of decrypted data content in the, apart from this, encrypted data stream, the danger of an unauthorized access to the data is minimized.

The replacement unit may be adapted in such a manner that data between a start position and an end position of the at least one intra-coded frame may be free from being replaced by corresponding portions of the decrypted data stream. The decryption only at the beginning and the end of an I-frame allows keeping the majority of an I-frame data block encrypted, and only necessary portions are decrypted and transmittable in plaintext. The adding unit may be located in a trick-play generation unit, whereas the replacement unit may be located at a recording side. The replacement unit may be further adapted to replace a PES packet length indicator, a Presentation Time Stamp (PTS) and/or a Decoding Time Stamp (DTS) in a header unit of the partially encrypted data stream.

The device according to the invention may be adapted to process an encrypted data stream of video data or audio data. However, such media content is not the only type of data that may be processed with the scheme according to the invention. Trick-play generation and similar applications are an issue for both, video processing and (pure) audio processing.

The device according to the invention may be adapted to process an encrypted data stream of digital data.

Furthermore, the device may comprise a trick-play generation unit adapted to generate a data stream for reproduction in a trick-play reproduction mode based on an output of the replacement unit. A user may adjust such a trick-play mode by selecting corresponding options in a user interface, for instance buttons of a device, a keypad or a remote control. The trick-play reproduction mode selected by a user which may require the information concerning the position of I-frames may be one of the group consisting of a fast forward reproduction mode, a fast reverse reproduction mode, a slow motion reproduction mode, a freeze frame reproduction mode, an instant replay reproduction mode, and a reverse reproduction mode. Other trick-play schemes are however possible. For trick-play, only a portion of subsequent data shall be used for output (for instance for visual display and/or for acoustical output). Since not all data (P-frames, B-frames) in a data stream can be used independently from other data (I-frames) for generating displayable signals, the knowledge of the independently usable data (I-frames) may be desired.

The device according to the invention may be adapted to process an encrypted MPEG2 data stream. MPEG2 is a designation for a group of audio and video coding standards agreed upon by MPEG (Moving Pictures Experts Group), and published as the ISO/IEC 13818 international standard. MPEG2 may be used to encode audio and video for broadcast signals including digital satellite and cable TV, but is also used for DVD.

The device according to the invention may be realized as at least one of the group consisting of a digital video recording device, a network-enabled device, a conditional access system, a portable audio player, a portable video player, a mobile phone, a DVD player, a CD player, a harddisk-based media player, an internet radio device, a public entertainment device, and an MP3 player. However, these applications are only exemplary.

Next, exemplary embodiments of the device for processing a data stream having a sequence of packets and timing information related to the packets will be described. These embodiments may also be applied for the method of processing a data stream having a sequence of packets and timing information related to the packets, for the computer-readable medium and for the program elements.

In this device, the distribution unit may be adapted to uniformly distribute packets related to a portion of the data stream between two subsequent intra-coded frames. In a broadcasting unit, different packets related to an I-frame may be provided in a non-equidistant manner. The distribution unit may re-arrange the packets equidistantly, that is to say smooth the distribution of the packets in the time domain. This smoothing may be performed independently for each packet group related to a particular I-frame. By taking this measure, it is possible to keep the local bit rate as small as possible, wherein the average rate remains the same.

The replacement unit may be adapted to arrange the modified timing information at a starting position of the processed data stream. Then, the timing information precedes the packets, thus an advantageous position for providing such timing information is obtained.

The replacement unit may further be adapted to generate a Program Clock Reference, a Decoding Time Stamp and/or a Presentation Time Stamp as the modified timing information. A Decoding Time Stamp/Presentation Time Stamp depends on a Program Clock Reference.

Particularly, the device may be adapted to process an encrypted data stream, and may comprise a decryption-information inserting unit adapted to insert decryption information in the processed data stream for decrypting the encrypted data stream. For instance, ECMs (Entitlement Control Messages) may be inserted as the decryption information by the decryption-information inserting unit. Particularly, it may be advantageous to insert the decryption information at an end of the processed data stream. More particularly, it may be possible that the timing information is prefixed to the actual data, and that the ECMs are provided at the end of the data, so that the data are sandwiched by the timing information and the decryption information.

As already mentioned above, the device may be adapted to process a data stream of video data or audio data. Particularly, pure visual data, pure audible data, or a mixture or combination of both may be processed according to the invention.

The device may be adapted to process a data stream of digital data. As mentioned above, trick-play generation may be possible. Different exemplary reproduction modes for trick-play are mentioned above.

As further mentioned above, it is possible to process an encrypted MPEG2 data stream. Furthermore, devices have been described above in which the device of the invention may be advantageously integrated.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a time-stamped transport stream packet.

FIG. 2 shows an MPEG2 group of picture structure with intra-coded frames and forward predictive frames.

FIG. 3 illustrates an MPEG2 group of picture structure with intra-coded frames, forward predictive frames and bi-directional predictive frames.

FIG. 4 illustrates a structure of a characteristic point information file and stored stream content.

FIG. 5 illustrates a system for trick-play on a plaintext stream.

FIG. 6 illustrates time compression in trick-play.

FIG. 7 illustrates trick-play with fractional distance.

FIG. 8 illustrates low speed trick-play.

FIG. 9 illustrates a general conditional access system structure.

FIG. 10 illustrates a digital video broadcasting encrypted transport stream packet.

FIG. 11 illustrates a transport stream packet header of the digital video broadcasting encrypted transport stream packet of FIG. 10.

FIG. 12 illustrates a system allowing performing trick-play on a fully encrypted stream.

FIG. 13 illustrates a full transport stream and a partial transport stream.

FIG. 14 illustrates a data transmission system between a broadcaster and a storage device for stream conversion.

FIG. 15 illustrates trick-play on a plaintext recording.

FIG. 16 illustrates trick-play on a fully encrypted recording.

FIG. 17 illustrates trick-play on a partially encrypted recording.

FIG. 18 illustrates a buffering demand for completely plaintext picture start code.

FIG. 19 illustrates practical plaintext area at the start of an I-frame.

FIG. 20A and FIG. 20B illustrate practical plaintext areas.

FIG. 21 illustrates picture start codes spread over two packets.

FIG. 22 illustrates empty P-frame appended to partially encrypted picture start code.

FIG. 23 illustrates plaintext data areas.

FIG. 24 illustrates a header structure in MPEG2 standard.

FIG. 25 illustrates sequence extension and sequence header code.

FIG. 26 illustrates picture coding extension and picture start code.

FIG. 27 illustrates sequence header code spread over two packets.

FIG. 28 illustrates packet smoothing in trick-play.

FIG. 29 illustrates DTS and PTS in relation to a PCR time base.

FIG. 30 illustrates inserting ECMs between trick-play GOPs.

FIG. 31 illustrates inserting ECMs within an I-frame.

FIG. 32 illustrates a signal path between a broadcast and a storage device and locations for conversion to a hybrid stream.

FIG. 33 illustrates generating secured trick-play from a fully encrypted recording.

FIG. 34A illustrates a hybrid stream generation block diagram of a device for processing an encrypted data stream according to an exemplary embodiment of the invention.

FIG. 34B illustrates a trick-play stream generation block diagram, which may be used together with the hybrid stream generation block diagram of FIG. 34A, of the device for processing an encrypted data stream according to the exemplary embodiment of the invention.

FIG. 35 illustrates data packets at different stages of a method of processing an encrypted data stream according to an exemplary embodiment of the invention.

FIG. 36 illustrates a device for processing a data stream having a sequence of packets and timing information related to the packets according to an exemplary embodiment of the invention.

### DESCRIPTION OF EMBODIMENTS

The illustration in the drawing is schematically. In different drawings, similar or identical elements are provided with the same reference signs.

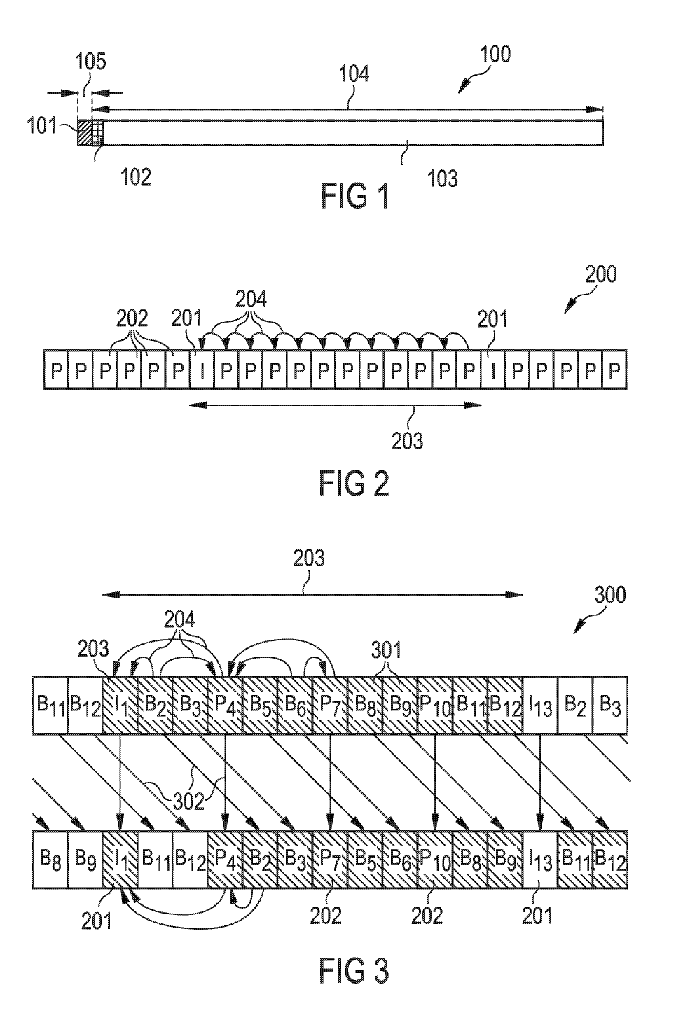

In the following, referring to FIG. 1 to FIG. 13, different aspects of trick-play implementation for transport streams according to exemplary embodiments of the invention will be described.

Particularly, several possibilities to perform trick-play on an MPEG2 encoded stream will be described, which may be partly or totally encrypted, or non-encrypted. The following description will target methods specific to the MPEG2 transport stream format. However, the invention is not restricted to this format.

Experiments were actually done with an extension, the so-called time-stamped transport stream. This comprises transport stream packets, all of which are pre-pended with a 4 bytes header in which the transport stream packet arrival time is placed. This time may be derived from the value of the program clock reference (PCR) time-base at the time the first byte of the packet is received at the recording device. This is a proper method to store the timing information with the stream, so that playback of the stream becomes a relatively easy process.

One problem during playback is to ensure that the MPEG2 decoder buffer will not overrun nor underflow. If the input stream was compliant to the decoder buffer model, restoring the relative timing ensures that the output stream is also compliant. Some of the trick-play methods described herein are independent of the time stamp and perform equally well on transport streams with and without time stamps.

FIG. 1 illustrates a time stamped transport stream packet 100 having a total length 104 of 188 Bytes and comprising a time stamp 101 having a length 105 of 4 Bytes, a packet header 102, and a packet payload 103 having a length of 184 Bytes.

This following description will give an overview of the possibilities to create an MPEG/DVB (digital video broadcasting) compliant trick-play stream from a recorded transport stream and intends to cover the full spectrum of recorded streams from those that are completely plaintext, so every bit of data can be manipulated, to streams that are completely encrypted (for instance according to the DVB scheme), so that only headers and some tables may be accessible for manipulation. The invention also addresses a solution in between these extremes, where only the data that needs to be manipulated to generate the trick-play stream is in plaintext.

When creating trick-play for an MPEG/DVB transport stream, problems may arise when the content is at least partially encrypted. It may not be possible to descend to the elementary stream level, which is the usual approach, or even access any packetized elementary stream (PES) headers before decryption. This also means that finding picture frames is not possible. Known trick-play engines need to be able to access and process this information.

In the frame of this description, the term “ECM” denotes an Entitlement Control Message. This message may particularly comprise secret provider proprietary information and may, among others, contain encrypted control words (CW) needed to decrypt the MPEG stream. Typically, control words expire in 10-20 seconds. The ECMs are embedded in packets in the transport stream.

In the frame of this description, the term “keys” particularly denotes data that may be stored in a smart card and may be transferred to the smart card using EMMs, that is so-called “Entitlement Management Messages” that may be embedded in the transport stream. These keys may be used by the smart card to decrypt the control words present in the ECM. An exemplary validity period of such a key is one month.

In the frame of this description, the term “control words” (CW) particularly denotes decryption information needed to decrypt actual content. Control words may be decrypted by the smart card and then stored in a memory of the decryption core.

In the following, some aspects related to trick-play on plaintext streams will be described.

Even if an MPEG2 stream is not encrypted (that is to say plaintext), trick-play is not trivial. An easy solution is just to output the data faster to a decoder to get a fast-forward mode, but as MPEG has timing related information encoded in its headers, this cannot just be done with the expectation to get a proper fast-forward. Besides that, it may be difficult to decide what frames to drop, as this method to perform fast-forward, may give a frame rate higher than the display rate.

Moreover, such a stream is not an MPEG2 compliant transport stream. This can be acceptable if the decoder is in the storage device but may be problematic if the signal is transferred by a standard digital interface. Furthermore, the bit rate may increase dramatically in the whole chain. If the normal play stream is a time stamped transport stream of a single program originating from satellite broadcast, the bit rate to the decoder in normal play may be around 40 Mbps and packets may be in irregular positions with gaps in between (partial transport stream). If the stream is compressed with the trick-play factor, the bit rate may be around 120 Mbps for a 3-fold (3×) trick-play speed. The necessary sustained bandwidth of a harddisk drive may also be increased with the trick-play factor.

So it would be appropriate to keep sending the correct amount of frames, but here a problem may occur when using a video coding technique like MPEG that exploits the temporal redundancy of video to achieve high compression ratios. Frames can no longer be decoded independently.

A structure of a plurality of groups of pictures (GOPs) is shown in FIG. 2.

Particularly, FIG. 2 shows a stream 200 comprising several MPEG2 GOP structures with a sequence of I-frames 201 and P-frames 202. The GOP size is denoted with reference numeral 203. The GOP size 203 is set to 12 frames, and only I-frames 201 and P-frames 202 are shown here.

In MPEG, a GOP structure may be used in which only the first frame is coded independently of other frames. This is the so-called intra-coded or I-frame 201. The predictive frames or P-frames 202 are coded with a unidirectional prediction, meaning that they only rely on the previous I-frame 201 or P-frame 202 as indicated by arrows 204 in FIG. 2.

Such a GOP structure has typically a size of 12 or 16 frames 201, 202. It is assumed that a trick-play speed of 2× forward is desired. So, for instance, every second frame should be skipped. This is not possible in the compressed domain due to the dependence on the reconstructed previous frame during decoding. So just dropping some compressed frames and fixing the timing information is no option.

The alternative is to decode the entire stream first, then skip every second frame and finally encode the remaining frames again. This may lead to an unacceptable complexity of the trick-play circuitry or software. So in the best case, some frames can be skipped from the GOP, on which no other frames rely. For the example of a trick-play speed of 2× with a GOP size of 12 frames, only the last 6 P-frames can be skipped. In this case, the displayed images tend to be of a “jumpy” nature, where a short normal speed period is obtained, followed by a sudden jump in time. Especially at higher trick-play speeds this may be unpleasant and does not give the viewer the look and feel of usual trick-play.

Another structure 300 of a plurality of groups of pictures (GOP) is shown in FIG. 3.

Particularly, FIG. 3 shows the MPEG2 GOP structure with a sequence of I-frames 201, P-frames 202 and B-frames 301. The GOP size is again denoted with reference numeral 203.

It is possible to use a GOP structure containing also bi-directionally predictive frames or B-frames 301 as shown in FIG. 3. A GOP size 203 of 12 frames is chosen for the example. The B-frames 301 are coded with a bi-directional prediction, meaning that they rely on a previous and a next I- or P-frame 201, 202 as indicated for some B-frames 301 by curved arrows 204. The transmission order of the compressed frames may be not the same as the order in which they are displayed.

To decode a B-frame 301, both reference frames before and after the B-frame 301 (in display order) are needed. To minimize the buffer demand in a decoder, the compressed frames may be reordered. So in transmission, the reference frames may come first. The reordered stream, as it is transmitted, is also shown in FIG. 3, lower part. The reordering is indicated by straight arrows 302. A stream containing B-frames 301 can give a nice looking trick-play picture if all the B-frames 301 are skipped. For the present example, this leads to a trick-play speed of 3× forward.

Whatever structure the stream has, the solutions described until now, may give an acceptable form of trick-play for a fast-forward mode. For reverse, the frames would have to be reordered in time, but due to the fact that MPEG uses the temporal correlation between successive frames to achieve a high compression ratio, the order in which the frames have to be decoded is fixed. Therefore, a GOP first has to be decoded in forward direction. The order of the GOPs sent to the decoder can be reversed, and GOPs can be skipped for higher reverse trick-play speeds. Reducing the GOPs by skipping P-frames or B-frames as described above is also possible in this case. Anyway, it may result in a displayed sequence of forward play and backward jumps. Therefore, the trick-play frames have to be selected from the decoded GOP and reversed in order, after which the frames are re-encoded. Then the previous GOP is fetched and processed and so on. Although possible, the complexity of such procedure may be high.

A conclusion from the foregoing considerations is that using only the I-frames in the trick-play generation may be a proper solution, because these frames can be decoded independently. As a result, the trick-play generation may be easier especially for reverse. Additionally, the use of only I-frames already allows for trick-play speeds down to 3× or 4×. For really low trick-play speeds, the more complex techniques mentioned above may be implemented.

In the following, some aspects related to a CPI (“characteristic point information”) file will be described.

Finding I-frames in a stream usually requires parsing the stream, to find the frame headers. Locating the positions where the I-frame starts can be done while the recording is being made, or off-line after the recording is completed, or semi on-line, in fact being off-line but with a small delay with respect to the moment of recording. The I-frame end can be found by detecting the start of the next P-frame or B-frame. The meta-data derived this way can be stored in a separate but coupled file that may be denoted as characteristic point information file or CPI file. This file may contain pointers to the start and eventually end of each I-frame in the transport stream file. Each individual recording may have its own CPI file.

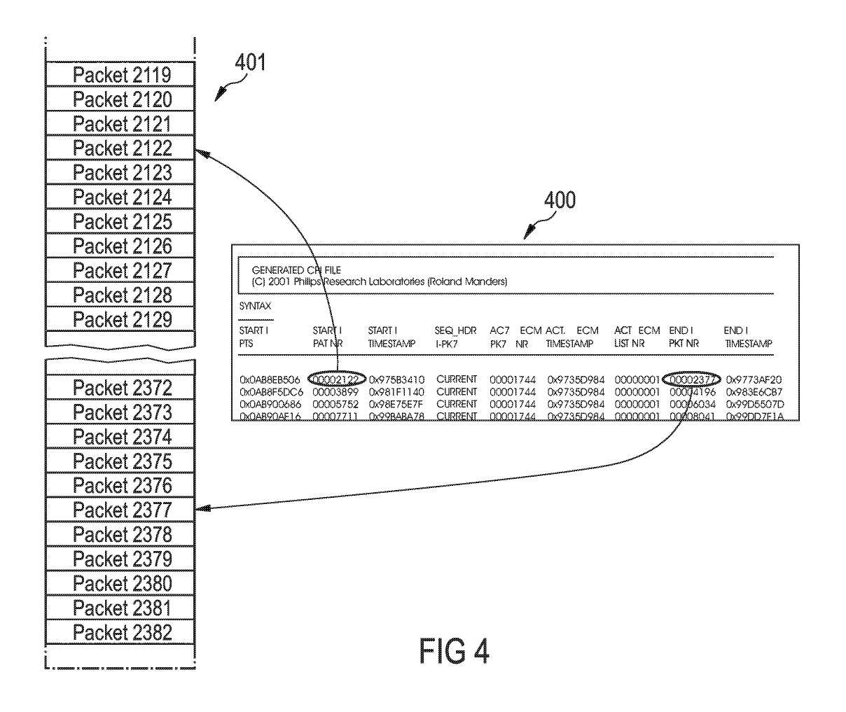

The structure of a characteristic point information file 400 is visualized in FIG. 4.

Apart from the CPI file 400, stored information 401 is shown. The CPI file 400 may also contain some other data that are not discussed here.

With the data from the CPI file 400 it is possible to jump to the start of any I-frame 201 in the stream. If the CPI file 400 also contains the end of the I-frames 201, the amount of data to read from the transport stream file is exactly known to get a complete I-frame 201. If for some reason the I-frame end is not known, the entire GOP or at least a large part of the GOP data is to be read to be sure that the entire I-frame 201 is read. The end of the GOP is given by the start of the next I-frame 201. It is known from measurements that the amount of I-frame data can be 40% or more of the total GOP data.

With the retrieved I-frames 201, a new trick-play stream that complies with the MPEG-2 transport stream format can be constructed. All that is needed is that the frames for the trick-play stream are re-multiplexed correctly, in such a manner that no buffer problems for the MPEG decoder will occur. Although this seems to be a straightforward solution, it is not a trivial solution as will become clear in the following.

Next, some aspects related to as to how to construct a trick-play stream will be described.

With the help of the CPI file, describing at what packet position an I-frame 201 starts, as well as where the I-frame 201 ends, access is provided to all I-frames 201 from the original stream. But just concatenating adequately chosen I-frames 201 into one big stream of only I-frames 201 does not result in a valid MPEG stream, as will become clear from the following.

The first point to investigate is the bit rate of the trick-play stream. For example, the original stream has an average video bit rate of 4 Mbps and a GOP size 203 of 12 frames. The bit rate may be extracted from a measurement on a real broadcast stream. It is assumed that the trick-play stream consists of I-frames 201 only that are each displayed one frame time, leading to a refresh rate of the trick-play stream equal to normal play. It is recalled that the amount of I-frame 201 data could be 40% of the GOP data. This number originates from a measurement, where the average has been around 25%. So on average 25% of the data have to be compressed into 1/12 of the time, leading to a 3 times higher bit rate. Thus the average trick-play bit rate would be 12 Mbps with peaks up to around 20 Mbps. This simple example is intended to provide some feeling for the bit rate effect and its origin.

In fact, the sizes of the I-frames 201 are known or are derivable from the measurement. Therefore, the bit rate for an I-frame 201 only trick-play stream as a function of time can easily be calculated accurately. The trick-play bit rate may be 2 to 3 times higher than the normal play bit rate and sometimes it may be higher than allowed by the MPEG2 standard. Taking into account that this is an example with a moderate bit rate stream and that streams with higher bit rates will surely be encountered, it is clear that some form of bit rate reduction has to be applied. For instance, the trick-play bit rate may be comparable to the normal play bit rate. This is especially important if the streams are sent to a decoder via a digital interface. Additional demand on bandwidth from the interface due to trick-play should be avoided. A first option is to reduce the size of the I-frames 201. However, this may add complexity and limitations in relation to trick-play for encrypted streams.

An option that may be appropriate for particular applications is to reduce the trick-play picture refresh rate by displaying each I-frame 201 several times. The bit rate will be reduced accordingly. This may be achieved by adding so-called empty P-frames 202 between the I-frames 201. Such an empty P-frame 202 is not really empty but may contain data instructing the decoder to repeat the previous frame. This has a limited bit cost, which can in many cases be neglected compared to an I-frame 201. From experiments it is known that trick-play GOP structures like IPP or IPPP may be acceptable for the trick-play picture quality and even advantageous at high trick-play speeds. The resulting trick-play bit rate is of the same order as the normal play bit rate. It is also mentioned that these structures may reduce the required sustained bandwidth from the storage device.

In the following, some aspects related to timing issues and stream construction will be described.

A trick-play system 500 is schematically depicted in FIG. 5.

The trick-play system 500 comprises a recording unit 501, an I-frame selection unit 502, a trick-play generation block 503 and an MPEG2 decoder 504. The trick-play generation block 503 includes a parsing unit 505, an adding unit 506, a packetizer unit 507, a table memory unit 508 and a multiplexer 509.

The recording unit 501 provides the I-frame selection unit 502 with plaintext MPEG2 data 510. The multiplexer 509 provides the MPEG2 decoder 504 with an MPEG2 DVB compliant transport stream 511.

The I-frame selector 502 reads specific I-frames 201 from the storage device 501. Which I-frames 201 are chosen depends on the trick-play speed as will be described below. The retrieved I-frames 201 are used to construct an MPEG-2/DVB compliant trick-play stream that is then sent to the MPEG-2 decoder 504 for decoding and rendering.

The position of the I-frame packets in the trick-play stream cannot be coupled to the relative timing of the original transport stream. In trick-play, the time axis may be compressed with the speed factor and additionally inversed for reverse trick-play. Therefore, the time stamps of the original time stamped transport stream may not be suitable for trick-play generation.

Moreover, the original PCR time base may be disturbing for trick-play. First of all it is not guaranteed that a PCR will be available within the selected I-frame 201. But even more important is that the frequency of the PCR time base would be changed. According to the MPEG2 specification, this frequency should be within 30 ppm from 27 MHz. The original PCR time base fulfils this requirement, but if used for trick-play it would be multiplied by the trick-play speed factor. For reverse trick-play this even leads to a time base running in the wrong direction. Therefore, the old PCR time base has to be removed and a new one added to the trick-play stream.

Finally, I-frames 201 normally contain two time stamps that tell the decoder 504 when to start decoding the frame (decoding time stamp, DTS) and when to start presenting, for instance displaying, it (presentation time stamp, PTS). Decoding and presentation may be started when DTS respectively PTS are equal to the PCR time base, which is reconstructed in the decoder 504 by means of the PCRs in the stream. The distance between, for example, the PTS values of two (2) I-frames 201 corresponds to their nominal distance in display time. In trick-play this time distance is compressed with the speed factor. Since a new PCR time base is used in trick-play, and because the distance for DTS and PTS is no longer correct, the original DTS and PTS of the I-frame 201 have to be replaced.

To solve above-mentioned complications, the I-frame 201 may first be parsed into an elementary stream in the parsing unit 505. Then the empty P-frames 202 are added on elementary stream level. The obtained trick-play GOP is mapped into one PES packet and packetized to transport stream packets. Then corrected tables like PAT, PMT, etc. are added. At this stage, a new PCR time base together with DTS and PTS are included. The transport stream packets are pre-pended with a 4 bytes time stamp that is coupled to the PCR time base such that the trick-play stream can be handled by the same output circuitry as used for normal play.

In the following, some aspects related to trick-play speeds will be described.

In this context, firstly, fixed trick-play speeds will be discussed.

As mentioned before, a trick-play GOP structure like IPP may be used in which two (2) empty P-frames 202 follows the I-frame 201. It is assumed that the original GOP has a GOP size 203 of 12 frames and that all the original I-frames 201 are used for trick-play. This means that the I-frames 201 in the normal play stream have a distance of 12 frames and the same I-frames 201 in the trick-play stream a distance of 3 frames. This leads to a trick-play speed of 12/3=4×. If the original GOP size 203 in frames is denoted by G, then the trick-play GOP size in frames is denoted by T and the trick-play speed factor by N_{b}, the trick-play speed in general is given by:

N_{b}=G/T (1)

N_{b} will also be denoted as the basic speed. Higher speeds can be realized by skipping I-frames 201 from the original stream. If every second I-frame 201 is taken, the trick-play speed is doubled, if every third I-frame 201 is taken, the trick-play speed is tripled and so on. In other words, the distance between the used I-frames 201 of the original stream is 2, 3 and so on. This distance may be always an integer number. Denoting the distance between the I-frames 201 used for trick-play generation by D (D=1 meaning that every I-frame 201 is used), then the general trick-play speed factor N is given by:

N=D*G/T (2)

This means that all integer multiples of the basic speed can be realized, leading to an acceptable set of speeds. It should be noticed that D is negative for reverse trick-play and that D=0 results in a still picture. Data can only be read in a forward direction. Therefore, in reverse trick-play, data is read forward and jumps are made backwards to retrieve the preceding I-frame 201 given by D. It should also be noticed that a larger trick-play GOP size T results in a lower basic speed. For instance, IPPP leads to a finer grained set of speeds than IPP.

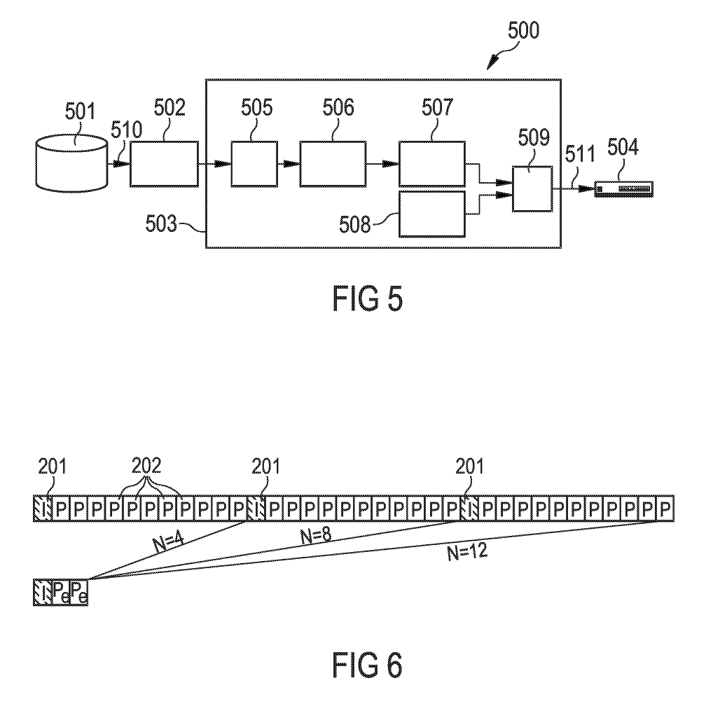

In the following, referring to FIG. 6, time compression in trick-play will be explained.

FIG. 6 shows the situation for T=3 (IPP) and G=12. For D=2, an original display time of 24 frames is compressed into a trick-play display time of 3 frames resulting in N=8. In the given example, the basic speed is an integer but this is not necessarily the case. For G=16 and T=3, the basic speed is 16/3=5⅓ which does not result in a set of integer trick-play speeds. Therefore, the IPPP structure (T=4) is better suited for a GOP size of 16 resulting in a basic speed of 4×. If a single trick-play structure is desired that fits to the most common GOP sizes of 12 and 16, IPPP may be chosen.

Secondly, arbitrary trick-play speeds will be discussed.

In some cases, the set of trick-play speeds resulting from the method described above is satisfying, in some cases not. In the case of G=16 and T=3 one probably still would prefer integer trick-play speed factors. Even in the case of G=12 and T=4 it might be preferred to have a speed not available in the set like for instance 7×. Now, the trick-play speed formula will be inverted and the distance D will be calculated which is given by:

D=N*T/G (3)

Using the above example with G=12, T=4 and N=7 results in D=2⅓. Instead of skipping a fixed number of I-frames 201, an adaptive skipping algorithm might be used that chooses the next I-frame 201 based on the fact what I-frame 201 best matches the required speed. To choose the best matching I-frame 201, the next ideal point Ip with the distance D may be calculated and one of the I-frames 201 may be chosen closest to this ideal point to construct a trick-play GOP. In the following step, again the next ideal point may be calculated by increasing the last ideal point by D.

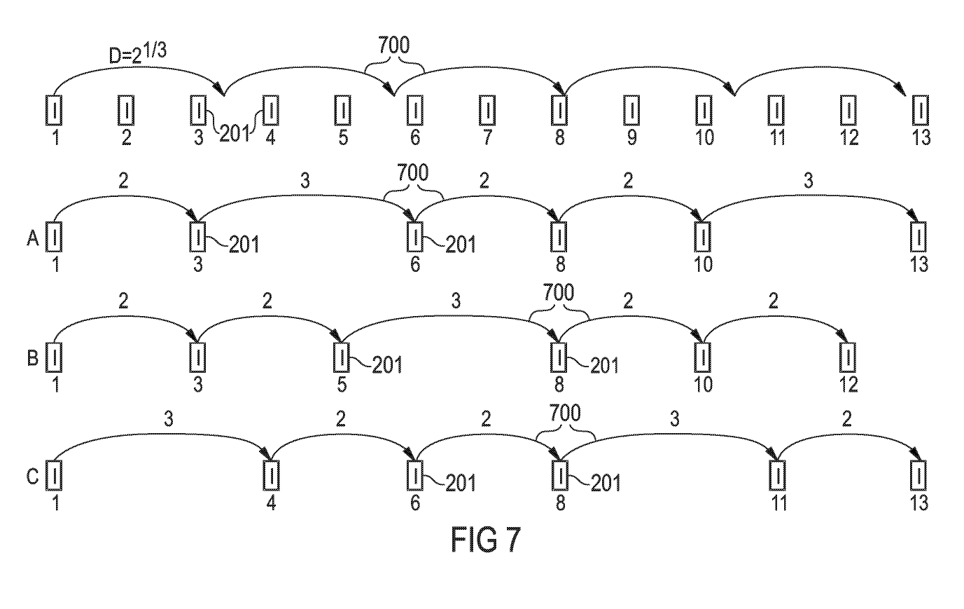

As visualized in FIG. 7 illustrating trick-play with fractional distances, there are particularly three possibilities to choose the I-frame 201:

A. The I-frame closest to the ideal point; I=round(Ip)

B. The last I-frame before the ideal point; I=int(Ip)

C. The first I-frame after the ideal point; I=int(Ip)+1

As can clearly be seen, the actual distance is varying between int(D) and int(D)+1, the ratio between the occurrences of the two being dependent on the fraction of D, such that the average distance is equal to D. This means that the average trick-play speed is equal to N, but that the actually used frame has a small jitter with respect to the ideal frame. Several experiments have been performed with this, and although the trick-play speed may vary locally, this is not visually disturbing. Usually, it is not even noticeable especially at somewhat higher trick-play speeds. It is also clear from FIG. 7 that it makes no essential difference whether to choose method A, B or C.

With this method, trick-play speed N does not need to be an integer but can be any number above the basic speed N_{b}. Also speeds below this minimum can be chosen, but then the picture refresh rate may be lowered locally because the effective trick-play GOP size T is doubled or at still lower speeds even tripled or more. This is due to a repetition of the trick-play GOPs, as the algorithm will choose the same I-frame 201 more than once.

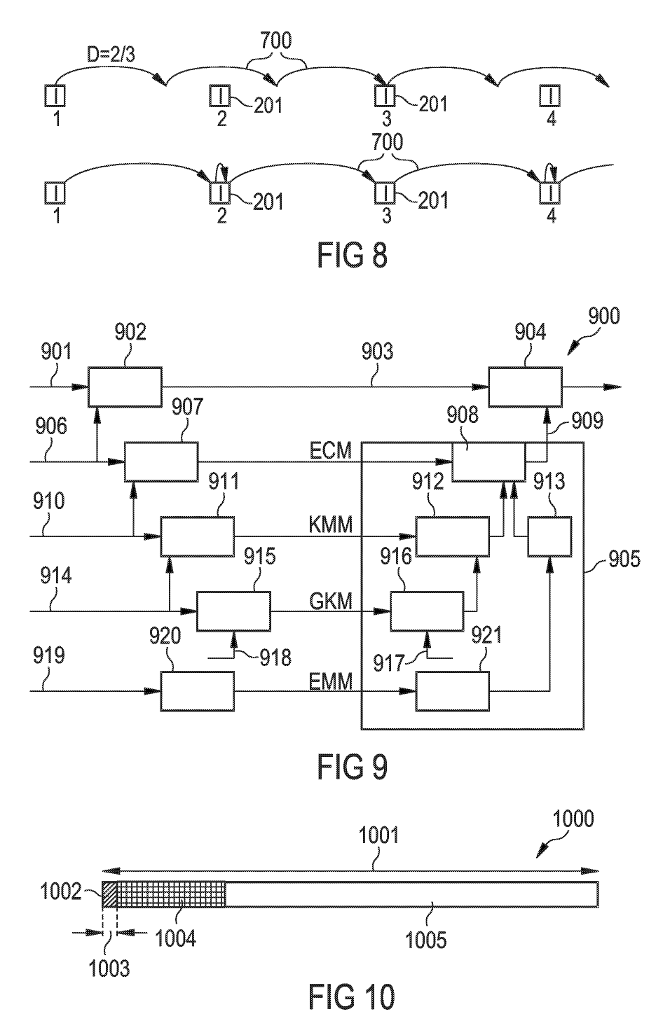

FIG. 8 shows an example for D=⅔ which is equivalent to N=⅔ N_{b}. Here, the round function is used to select the I-frames 201 and as can be seen frames 2 and 4 are selected twice.

Anyway, the described method will allow for a continuously variable trick-play speed. For reverse trick-play a negative value is chosen for N. For the example of FIG. 7 this simply means that the arrows 700 are pointing in the other direction. The method described will also include the sets of fixed trick-play speeds mentioned earlier and they will have the same quality, especially if the round function is used. Therefore, it might be appropriate that the flexible method described in this section should always be implemented whatever the choice of the speeds will be.

In the following, some aspects related to the refresh rate of the trick-play picture will be discussed.

The term “refresh rate” particularly denotes the frequency with which new pictures are displayed. Although not speed dependent, it will be briefly discussed here because it can influence the choice of T. If denoting the refresh rate of the original picture by R (25 Hz or 30 Hz), the refresh rate of the trick-play picture (Rₜ) is given by:

Rₜ=R/T (4)

With a trick-play GOP structure of IPP (T=3) or IPPP (T=4), the refresh rate Rₜ is 8⅓ Hz respectively 6¼ Hz for Europe and 10 Hz respectively 7½ Hz for the USA. Although the judgment of trick-play picture quality is a somewhat subjective matter, there are clear hints from experiments that these refresh rates are acceptable for low speeds and even advantageous at higher speeds.

In the following, some aspects related to encrypted stream environments will be described.

In the following, some information about encrypted transport streams is presented as a basis for the description of trick-play on encrypted streams. It is focused on the Conditional Access System used for broadcast.

FIG. 9 illustrates a conditional access system 900 that will be described in the following.

In the conditional access system 900, content 901 may be provided to a content encryption unit 902. After having encrypted the content 901, the content encryption unit 902 supplies a content decryption unit 904 with encrypted content 903.

A control word 906 may be supplied to the content encryption unit 902 and to an ECM generation unit 907. The ECM generation unit 907 generates an ECM and provides the same to an ECM decoding unit 908 of a smart card 905. The ECM decoding unit 908 generates from the ECM a control word that is decryption information that is needed and provided to the content encryption unit 904 to decrypt the encrypted content 903.

Furthermore, an authorization key 910 is provided to the ECM generation unit 907 and to a KMM generation unit 911, wherein the latter generates a KMM and provides the same to a KMM decoding unit 912 of the smart card 905. The KMM decoding unit 912 provides an output signal to the ECM decoding unit 908.

Moreover, a group key 914 may be provided to the KMM generation unit 911 and to a GKM generation unit 915 which may further be provided with a user key 918. The GKM generation unit 915 generates a GKM signal GKM and provides the same to a GKM decoding unit 916 of the smart card 905, wherein the GKM decoding unit 916 gets as a further input a user key 917.

Beyond this, entitlements 919 may be provided to an EMM generation unit 920 that generates an EMM signal and provides the same to an EMM decoding unit 921. The EMM decoding unit 921 located in the smart card 905 is coupled with an entitlement list unit 913 which provides the ECM decoding unit 908 with corresponding control information.

ECM denotes Entitlement Control Messages, KMM denotes Key Management Messages, GKM denotes Group Key Messages, and EMM denotes Entitlement Management Messages.

In many cases, content providers and service providers want to control access to certain content items through a conditional access (CA) system.

To achieve this, the broadcasted content 901 is encrypted under the control of the CA system 900. In the receiver, content is decrypted before decoding and rendering if access is granted by the CA system 900.

The CA system 900 uses a layered hierarchy (see FIG. 9). The CA system 900 transfers the content decryption key (control word CW 906, 909) from server to client in the form of an encrypted message, called ECM (Entitlement Control Message). ECMs are encrypted using an authorization key (AK) 910. For security reasons, the CA server 900 may renew the authorization key 910 by issuing a KMM (Key Management Message). A KMM is in fact a special type of EMM (Entitlement Management Message), but for clarity the term KMM may be used. KMMs are also encrypted using a key that for instance can be a group key (GK) 914, which is renewed by sending a GKM (Group Key Message) that is again a special type of EMM. GKMs are then encrypted with the user key (UK) 917, 918, which is a fixed unique key embedded in the smart card 905 and known by the CA system 900 of the provider only. Authorization keys and group keys are stored in the smart card 905 of the receiver.

Entitlements 919 (for instance viewing rights) are sent to individual customers in the form of an EMM (Entitlement Management Message) and stored locally in a secure device (smart card 905). Entitlements 919 are coupled to a specific program. An entitlements list 913 gives access to a group of programs depending on the type of subscription. ECMs are only processed into keys (control words) by the smart card 905 if an entitlement 919 is available for the specific program. Entitlement EMMs are subject to an identical layered structure as the KMMs (not depicted in FIG. 9).

In an MPEG2 system, encrypted content, ECMs and EMMs (including the KMM and GKM types) are all multiplexed into a single MPEG2 transport stream.

The description above is a generalized view of the CA system 900. In digital video broadcasting, only the encryption algorithm, the odd/even control word structure, the global structure of ECMs and EMMs and their referencing are defined. The detailed structure of the CA system 900 and the way the payloads of ECMs and EMMs are encoded and used are provider specific. Also the smart card is provider specific. However, from experience it is known that many providers follow essentially the structure of the generalized view of FIG. 9.

In the following, DVB Encryption/Decryption topics will be discussed.

The applied encryption and decryption algorithm is defined by the DVB standardization organization. In principle two encryption possibilities are defined namely PES level encryption and TS level encryption. However, in real life mainly the TS level encryption method is used. Encryption and decryption of the transport stream packets is done packet based. This means that the encryption and decryption algorithm is restarted every time a new transport stream packet is received. Therefore, packets can be encrypted or decrypted individually. In the transport stream, encrypted and plaintext packets are mixed because some stream parts are encrypted (e.g. audio/video) and others are not (e.g. tables). Even within one stream part (e.g. video) encrypted and plaintext packets may be mixed.

In the following, referring to FIG. 10, a DVB encrypted transport stream packet 1000 will be described.

The stream packet 1000 has a length 1001 of 188 Bytes and comprises three portions. A packet header 1002 has a size 1003 of 4 Bytes. Subsequent to the packet header 1002, an adaptation field 1004 may be included in the stream packet 1000. After that, a DVB encrypted packet payload 1005 may be sent.

FIG. 11 illustrates a detailed structure of the transport stream packet header 1002 of FIG. 10.

The transport stream packet header 1002 comprises a synchronization unit (SYNC) 1010, a transport error indicator (TEI) 1011 which may indicate transport errors in a packet, a payload unit start indicator (PLUSI) 1012 which may particularly indicate a possible start of a PES packet in the subsequent payload 1005, a transport priority unit (TPI) 1017 indicating priority of the transport, a packet identifier (PID) 1013 used for determining the assignment of the package, a transport scrambling control (SCB) 1014 is used to select the CW that is needed for decrypting the transport stream packet, an adaptation field control (AFLD) 1015, and a continuity counter (CC) 1016. Thus, FIG. 10 and FIG. 11 show the MPEG2 transport stream packet 1000 that has been encrypted and which comprises different parts:
Packet header 1002 is in plaintext. It serves to obtain important information such as a packet identifier (PID) number, presence of an adaptation field, scrambling control bits, etc.
Adaptation field 1004 is also in plaintext. It can contain important timing information such as the PCR.
DVB Encrypted Packet Payload 1005 contains the actual program content that may have been encrypted using the DVB algorithm.

In order to select the correct CW that is needed to decrypt the broadcasted program it is necessary to parse the transport stream packet header. A schematic overview of this header is given in FIG. 11. An important field for the decryption of the broadcasted program is the scrambling control bits (SCB) field 1014. This SCB field 1014 indicates which CW the decrypter must use to decrypt the broadcasted program. Moreover, it indicates whether the payload of the packet is encrypted or in plaintext. For every new transport stream packet, this SCB 1014 must be parsed since it changes over time and can change from packet to packet.

In the following, some aspects related to trick-play on fully encrypted streams will be described.

The first reason why this is an interesting topic is that trick-play on plaintext and fully encrypted streams are the two extremes of a range of possibilities. Another reason is that there exist applications in which it may be necessary to record fully encrypted streams. Thus, it would be useful to have a technique at hand to perform trick-play on a fully encrypted stream. A basic principle is to read a large enough block of data from the storage device, decrypt it, select an I-frame in the block and construct a trick-play stream with it.

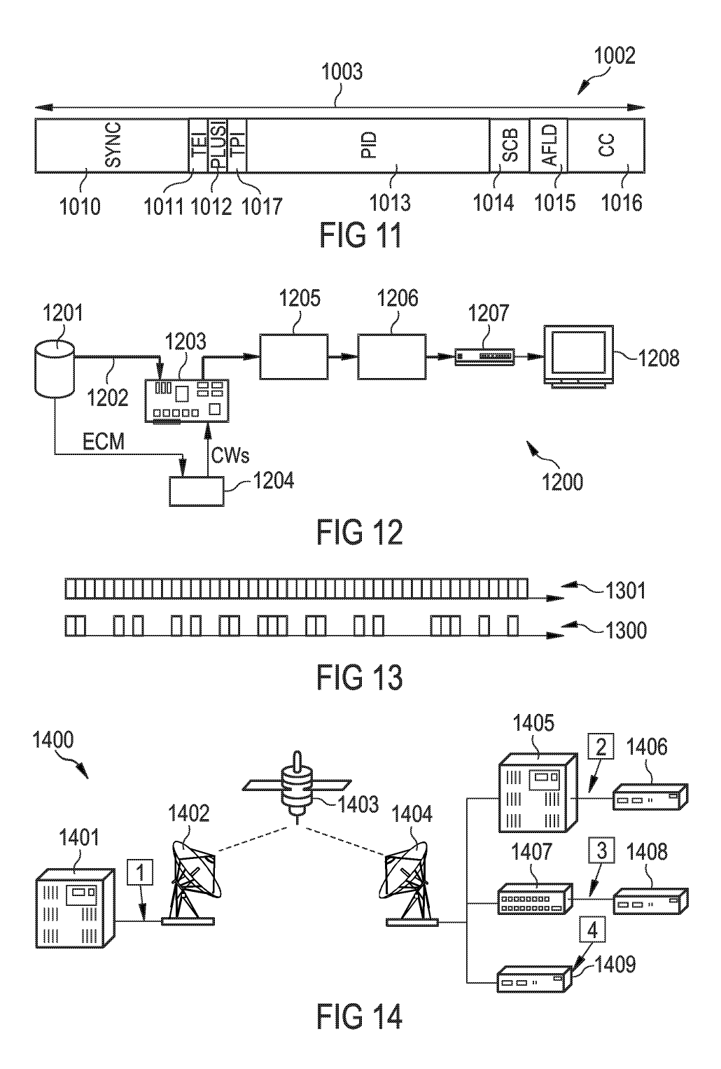

Such a system 1200 is depicted in FIG. 12

FIG. 12 shows the basic principle of trick-play on a fully encrypted stream. For this purpose, data stored in a harddisk 1201 are provided as a transport stream 1202 to a decrypter 1203. Further, the harddisk 1201 provides a smart card 1204 with an ECM, wherein the smart card 1204 generates control words from this ECM and sends the same to the decrypter 1203.

Using the control words, the decrypter 1203 decrypts the encrypted transport stream 1202 and sends the decrypted data to an I-frame detector and filter 1205. From there, the data are provided to an insert empty P frame unit 1206 that conveys the data to a set top box 1207. From there, data are provided to a television 1208.

In the following, some aspects will be mentioned with respect to the question what a recording contains.

Making a recording of a single channel, the recording must contain all the data required to playback the recording of the channel at a later stage. One can resort to just record everything on a certain transponder, but this way one would record far more than one needs to playback the program intended to record. This means that both bandwidth and storage space would be wasted. So instead of this, only the packets really needed should be recorded. For each program this means one must record all the MPEG2 mandatory packets like PAT (program association table), CAT (conditional access table), and obviously for each program the video and audio packets as well as the PMT (program map table) that describes which packets belong to a program. Furthermore, the CAT/PMT may describe CA packets (ECMs) needed for decryption of the stream. Unless the recording is made in plaintext after decryption, those ECM packets have to be recorded as well.

If the recording made does not consist of all packets from the full multiplex, the recording becomes a so-called partial transport stream 1300 (see FIG. 13). Further, FIG. 13 illustrates a full transport stream 1301. The DVB standard requires that if a partial transport stream 1300 is played, all normal DVB mandatory tables like NIT (network information table), BAT (bouquet association table) etcetera are removed. Instead of these tables, the partial stream should have SIT (selection information table) and DIT (discontinuity information table) tables inserted.

In the following, referring to FIG. 14 to FIG. 36, systems will be described which are capable of processing a data stream according to exemplary embodiments of the invention.

It is emphasized that the systems described in the following can be implemented in the frame of and in combination with any of the systems described referring to FIG. 1 to FIG. 13.

In the following, aspects related to trick-play on hybrid streams will be described.

Next, plaintext I-frames will be discussed.

A recording in which the I-frames 201 are in plaintext and the remainder encrypted is an alternative to a fully plaintext stream from the viewpoint of special storage functionality like fast-forward/reverse.

In the following, referring to FIG. 14, a system 1400 for transmitting data between a broadcaster 1401 and storage devices 1406, 1408, and 1409 according to an exemplary embodiment of the invention will be described.

A broadcaster 1401 transmits data to a satellite dish 1402 from where, via a satellite 1403, the data is provided to a satellite dish 1404. From the satellite dish 1404, the data are provided to a cable head end 1405, to a residential gateway 1407 and to a storage device 1409. From the cable head end 1405, the data may be further transmitted to the storage device 1406. From the residential gateway 1407, the data may be further transmitted to a storage device 1408.

As shown in FIG. 14, particularly four different methods are possible how an I-frame plaintext stream may be generated. As denoted with “1”, the broadcaster 1401 may generate an I-frame plaintext stream. As denoted with “2”, the cable head 1405 may generate an I-frame plaintext stream. As denoted with “3”, the residential gateway 1407 may generate an I-frame plaintext stream. As denoted with “4”, the storage device 1409 may generate an I-frame plaintext stream.

As depicted in FIG. 14, there are several places in the supply chain where such a stream could be constructed.

Options “1” and “2” may be favorable situations in which no actions are needed in the consumer equipment. In case “3”, the actions may be limited to only one home device being the residential gateway 1407. Option “4” might be most realistic.

At the input of the storage unit itself, the stream now may contain at least plaintext I-frames and the remainder can be encrypted or also in plaintext depending on the kind of transmission that is being stored. This means that in all cases CPI data related to the I-frame start points and endings can be generated. The data retrieved using the CPI data during trick-play now only contains plaintext I-frames. This means that, for the trick-play system, there may be no difference between trick-play on a fully plaintext stream and such a hybrid stream.

In the following, aspects related to plaintext packets will be described.

One possibility is that the generated trick-play stream is completely plaintext whether the original stream is plaintext or (partially) encrypted. This is not a problem if trick-play engine and decoder/renderer are in one and the same device. But if the trick-play stream is created inside a server, and then distributed across a network, having the trick-play stream in plaintext may not be desired or allowed by the content provider. The same may be true for normal play.

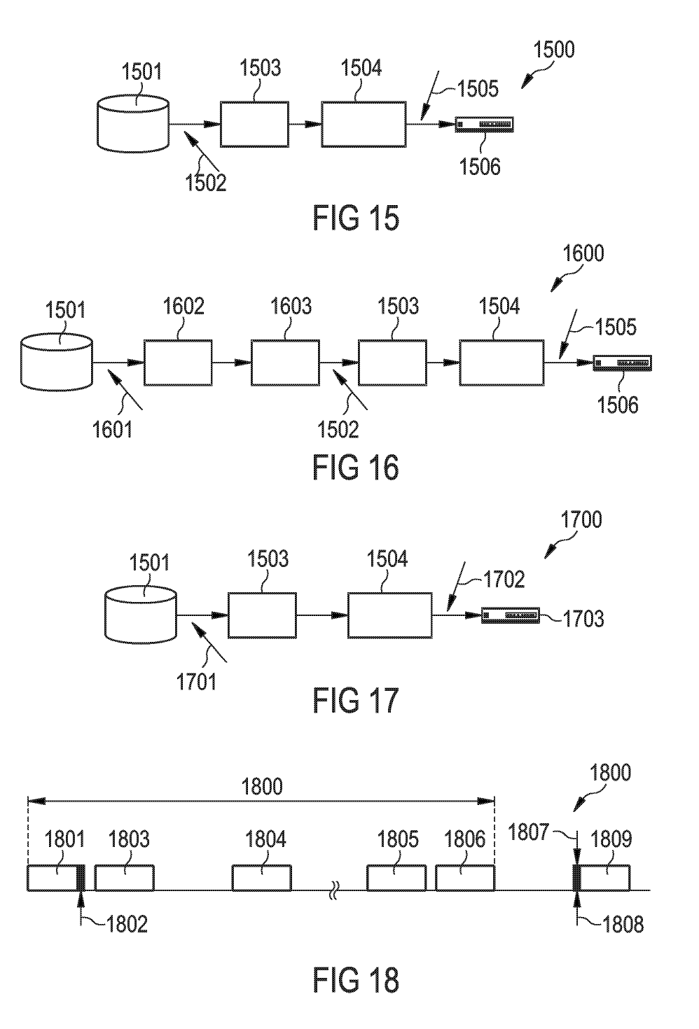

In the following, referring to FIG. 15, a system 1500 will be described related to trick-play on a plaintext recording.

A recording unit 1501 is connected to a frame selector unit 1503 and provides the latter with plaintext MPEG2 data 1502. The frame selector unit 1503 is coupled with a trick-play generation unit 1504 that provides an MPEG2 decoder 1506 with an MPEG2 DVB compliant transport stream 1505.

If the original recorded stream is in plaintext as depicted in FIG. 15, it should be no problem that the trick-play stream is also in plaintext. But even on a stream that was recorded while still being fully encrypted, a trick-play stream may be generated that is fully in plaintext as shown in FIG. 16.

In addition to the system 1500, the system 1600 further comprises a block selector unit 1602 that is provided with encrypted MPEG2 data 1601 from the recording device 1501. Further, a decrypter unit 1603 is provided between the block selector unit 1602 and the frame selector unit 1503.

In this situation, a plaintext trick-play stream may not be desirable. Under particular circumstances, it may not be possible to simply skip the decrypter as no trick-play stream can be constructed from a fully encrypted stream. A solution could be to encrypt the generated plaintext trick-play stream again. It may be necessary to adjust what key-schedule (CWs, ECMs, etc.) and encryption algorithm should be used. For example, it may be not allowed to add a DVB encrypter to a consumer device, so another encryption format should be chosen in such a case. This could be another cipher like DES, 3DES, AES, etc. Doing that would mean that current set-top boxes (STBs) are not able to decrypt the trick-play stream. Besides that, normal play is realized by streaming the original DVB encrypted stream to the STB without any modifications on the encryption level. So an adapted box would not only need to be able to decrypt another format, it would also have to be able to decide which of the formats to use on what part of the received stream. This may be not trivial because no such indication is present in the stream itself. Inherently, trick-play would have to be handled different from normal play.

A desirable solution would be that both normal play and trick-play are in the DVB encryption format, but it may be not allowed to use a DVB encrypter.

In the following, a basic solution to the encryption problem will be described.

It will be explained how it is possible to generate a DVB encrypted trick-play stream even in a scenario in which the use of a DVB encryption engine at home is not allowed. First of all, it is noted that an encrypted trick-play stream should only be necessary if the original normal play stream is also encrypted. With this in mind, the trick-play stream may be constructed directly from the encrypted normal play transport stream packets. This implies that generation of a trick-play stream on elementary stream level may be no longer possible. It should be generated directly on the transport stream level.

For this trick-play generation, it may be at least necessary to know where the I-frames are located in the encrypted normal play transport stream. This could be achieved by decrypting the stream, by detecting the I-frames and by generating pointers to the start and end of the I-frame in the encrypted stream. But for the generation of a valid trick-play stream it may be necessary to alter some data in the encrypted payload of some packets. This can only be done if these packets are first decrypted and then adapted. However, the adapted packets cannot be re-encrypted. Therefore, some packets in the trick-play stream will always be in plaintext. Preferably, these packets are already recorded in plaintext. These plaintext packets then also allow for a direct detection of the I-frame position that is then stored in the CPI file.

Trick-play on a partially encrypted recording is illustrated in FIG. 17.

In system 1700 shown in FIG. 17, when compared to FIG. 15, the frame selector unit 1503 is provided with partially encrypted MPEG2 data 1701 by the recording unit 1501. Further, the trick-play generation unit 1504 provides an MPEG2 decoder and decrypter unit 1703 with an MPEG2 DVB compliant transport stream 1702 being partially encrypted.

The amount of plaintext data in the stream should be minimized such that it effectively is still a well-protected encrypted stream. In the following, the term “hybrid stream” may indicate such a stream.

In the following, it will be described which parts of a data stream should minimally be in plaintext.

As mentioned above, not just everything is decrypted, but only what is really needed. To find out what is needed, a practical broadcast stream has been analyzed.
Apart from the discontinuities in the continuity counter, which is located in the plaintext packet header, the first things that need to be adapted are the PTS/DTS fields in the PES header. So the transport stream packet is needed that contains those fields to be plaintext. This also means that the packet at which the I-frame starts is usually in plaintext.
The next thing that may be wrong is the last packet from the I-frame, which can also contain the start of the next P-frame or B-frame. So that packet may be fixed-up by removing all non-I-frame data and stuffing the packet. Therefore, this packet should be in plaintext as well.
All the packets in between these two only contain I-frame video data that can be used as is and therefore stay encrypted.
To add correct empty frames, it may be necessary to know the resolution of the picture, and to add a new time base it may be needed to know the frame rate. All necessary data can be found in the PES/ES header fields.

It is not guaranteed that the entire PES/ES headers are in the packet with the PLUSI. If all header data is not in one packet, the next packet(s) is or are needed in plaintext as well, so that there is access to the fields described below.

In the PES header, guaranteed to start in the PLUSI packet, it may be necessary to alter three fields:
PES_packet_length
PTS (presentation time stamp)
DTS (decoding time stamp)

PTS and DTS are not mandatory. They should however be altered when they are present.

To create the correct type of empty P-frames, to add the new time base and to correct the temporal reference of the I-frame some data from the ES headers may be needed.

First of all, from the sequence header it may be needed:
Horizontal_size_value
Vertical_size_value
Frame_rate_code

In the sequence extension, there is one flag which may be important:
Progressive sequence flag

In the picture header, one item might need to be changed:
Temporal reference

Finally, from the picture coding extension, it may be necessary to access these two fields:
Picture_structure
Top_field_first

After retrieving this data, it is possible to decide on the type of empty frame that shall be added. It is possible to use a previously created lookup table that contains empty frames created for all possible combinations above, taking the MPEG2 restrictions into account. Although the specifications do not require that all these fields are present for each GOP, it is believed that no broadcast signal exists that skipped these fields. A reason may be that a decoder will also need to have access to these headers to decode the data correctly as soon as possible after zapping stations.

So all what may be needed in plaintext for each I-frame are a few packets, at least one at the start and one at the end. This also has the advantage that it is possible to easily determine the exact position of each I-frame. Streams with only these packets in plaintext are effectively still completely encrypted. The first packet of each I-frame usually contains almost no video data, but exists solely of (P)ES header data. The last packet of the I-frame may also contain some data of the next P-frame or B-frame, but this will be removed anyway.

In the following, it will be discussed how to select the packets that should be in plaintext.

When a hybrid stream is constructed, it should be decided which packets should be in plaintext. To enable the detection and selection of needed plaintext data, the video stream may be first completely decrypted. Then, the location of this data may be determined in the plaintext stream and the plaintext packets in which it is located may replace the encrypted packets in the original stream to form the hybrid stream.

To select the plaintext data, the following three criteria may be used:

1. The DTS/PTS in the PES header may be changed if they are present. For this purpose, all of the PES header data may be put in plaintext. This means that the packets ranging from the one with the PLUSI bit set to the one containing the last byte of the PES header may be all put in plaintext.

2. Some information from the sequence header and sequence extension may be needed. For this purpose, all of the data from the sequence header up to the picture start code may be put in plaintext. Sequence header and picture start code may be detected by checking for a four bytes code. These four bytes are not necessarily located in one and the same packet. Sequence header and picture start code are detected when the last of the four bytes is found. To avoid excessive buffering for the construction of the hybrid stream, the packets ranging from the one containing the fourth byte of the sequence header up to the one containing the fourth byte of the picture start code may be all put in plaintext. This can lead to some peculiar situations when searching for sequence header and picture start code in the resulting hybrid stream.

3. The picture start code may be needed to detect the frame boundaries. So a packet containing a picture start code should be put in plaintext. The two bytes following the picture start code should also be in plaintext. These bytes contain the temporal reference that might be needed to be changed and the picture coding type that identifies an I-frame, P-frame or B-frame. Moreover, some information may be needed from the picture coding extension. For this purpose, all of the data from the picture start code up to the end of the picture coding extension may be put in plaintext. The picture start code may be detected when the fourth byte is found. To avoid excessive buffering, the packets ranging from the one containing the fourth byte of the picture start code up to the one containing the last byte of the picture coding extension may all be put in plaintext. This will result in plaintext packets on all frame boundaries, which is more than needed for the construction of the trick-play streams discussed this far. But it may be necessary for the construction of a slow motion forward stream.

In the following, it will be explained what excessive buffering means and what causes it. If a hybrid stream is constructed, packets from the original encrypted stream and the decrypted stream may be combined in one stream. If done in real-time, some buffering may be needed. It may be assumed that the picture start code is spread over two video packets. This four bytes picture start code may be detected in the decrypted stream at the moment that the last byte is found. To have the complete picture start code in plaintext means that not only the video packet with this last byte should be in plaintext but also the preceding video packet.

Other data can be and regularly will be in between these two video packets. In principle, this can be a large amount of packets.

In the following, referring to FIG. 18, a system 1800 will be described showing the buffering demand for completely plaintext picture start code.

In FIG. 18, a buffer 1800 is shown starting with an I-frame 1801 having at the end thereof a part of picture start code 1802. Subsequently, an audio block 1803 is shown. A further audio block 1804 is shown. Moreover, a PSI block 1805 and a data block 1806 are shown. At a picture start code detection moment 1807, a block comprising a part of picture start code 1808 and a subsequent P-frame 1809 is started.

FIG. 18 shows an example of a situation where the picture start code at the end of the I-frame is spread over two video packets. In this case not only these two video packets have to be buffered but also all the packets with other data in between these two video packets. Although the picture start code is shown in the example, it will be clear that the same argument is valid for the sequence header code. The given criteria reduce the necessary buffering to only one packet. If one of the three defined criteria is met, the corresponding packets will be put in plaintext. The combination of the three criteria will often lead to only one plaintext packet at each frame boundary. However, in some practical cases for some streams, it can also be a few packets. Theoretically, it can even be a large number of packets.

A first example is a stream composed of only I-frames and P-frames with a GOP size of 12 frames and one PES packet per GOP. In performed experiments, the number of plaintext packets at the start of the I-frame has been always one. The number of plaintext packets at the end of the I-frame and in fact at all other frame boundaries is usually one, but may be sometimes two. At the start of the I-frame, everything from PES header to picture coding extension is in one packet. The plaintext packets at other frame boundaries contain all data from the picture start code to the end of the picture coding extension. This data can be spread over two packets.

A second example is a stream composed of I-frames, P-frames and B-frames with an IBP structure, a varying GOP size with even values ranging from 2 to 12 and one PES packet per frame. The number of plaintext packets at the start of the I-frame has been mostly two and at the end of the I-frame and other frame boundaries always one. The two packets at the start of the I-frame are mainly due to the presence of a quantising table in the sequence header. At the end of the I-frame and other frame boundaries, the data from PES header to picture coding extension is all in one packet.

It should be noticed that due to the PES structure for the second example it is not the last packet of the I-frame that is in plaintext but in fact the first packet of the next frame. For the first example, this can also occur sometimes. This is no problem because the last packet of the I-frame only contains I-frame data in this case and does not need to be cleaned up. It should also be noticed that, in practice, the combination of the three selection criteria leads to one contiguous plaintext video area at each frame boundary. In theory, this need not be the case. The combination of criteria 2 and 3 always leads to a contiguous area, but theoretically the plaintext PES header area can be a separate one.

In the following, it will be explained how to find the necessary information in the hybrid stream.

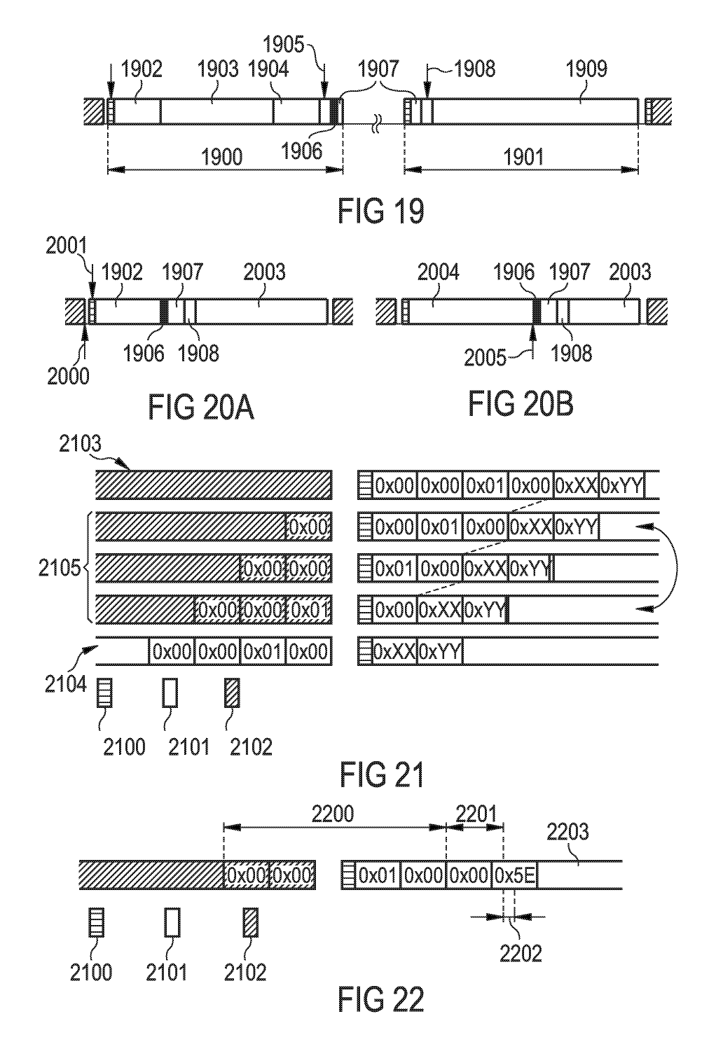

As mentioned above, there may be in practice one contiguous plaintext area at each frame boundary. At the start of the I-frame (GOP), the plaintext data runs from the first byte of the PES header to at least the last byte of the picture coding extension. An example is given in FIG. 19. All necessary data is in this area and can easily be found by parsing this part of the stream that starts at a packet marked with a PLUSI.

In the following, referring to FIG. 19, a practical plaintext area at the start of an I-frame will be explained.

The data stream shown in FIG. 19 includes a first I-frame packet 1900 and a subsequent second I-frame packet 1901. The first I-frame packet 1900 comprises a PES header 1902, a sequence header 1903, a sequence extension 1904, a GOP header 1905, a picture start code 1906 and a picture header 1907. Further, the second I-frame packet 1901 includes also picture header 1907, a subsequent picture coding extension 1908 and an I-frame data block 1909.

In the following, the data streams shown in FIG. 20A and FIG. 20B will be described.

In the data stream of FIG. 20A, the end of an I-frame 2000 is indicated. A PLUSI 2001 precedes a PES header 1902, and then a picture start code 1906 is provided. After that, a picture header 1907 is sent, and then a picture encoding extension 1908. Subsequently, a P- or B-frame data block 2003 is following.

In the data stream of FIG. 20B, a last I-frame data 2004 terminates at the end of an I-frame 2005, and after that a picture start code 1906, a picture header 1907, a picture coding extension 1908 and a P- or B-frame data block 2003 are following.

At the end of the I-frame, there are in practice two possibilities.

1. In the case of one PES packet per frame, the plaintext area at (after) the end of the I-frame 2000 also starts with the first byte of the PES header 1902 and runs to at least the last byte of the picture coding extension 1908. All necessary data may be easily found and no cleaning of the last packet of the I-frame is needed (see FIG. 20A).

2. In the case of one PES packet per GOP, there is no PES header after the end of the I-frame. In practice, there is also no sequence header in this position. In this case, the packets containing the fourth byte of the picture start code 1906 up to the last byte of the picture coding extension 1908 are in plaintext (see FIG. 20B). The four bytes picture start code 1906 could be spread over two packets, for instance the first three bytes in one packet and the last byte in the next packet. In this case, the first three bytes may be still encrypted. This seems to implicate that this picture start code 1906 cannot be detected in the hybrid stream. How this problem can be solved will be described hereafter.

There may be in fact a plaintext area at each frame boundary. So detecting the end of an I-frame means a search for the first picture start code after the one for the I-frame. It should be clear that only the plaintext video packets should be searched for this code to avoid a false positive match in the encrypted data. Whether the payload of a packet is in plaintext or not is indicated by the scrambling control bits in the packet header. The detection gives a positive match only when a given sequence of four bytes is found (0x00 0x00 0x01 0x00). This sequence corresponds to a picture start code disregarding the type of frame. Unfortunately, the picture start code does not have to be aligned on transport stream packet boundaries. That means that if the picture start code were spread over two packets, only the second one of those packets would be in plaintext. This situation is depicted in FIG. 21.

In FIG. 21, a packet header is indicated by reference numeral 2100, a packet payload plaintext is indicated by reference numeral 2101, and a packet payload encrypted is indicated by reference numeral 2102.

A top line 2103 indicates a picture start code that is completely located in the second packet. For the bottom line 2104, it is completely in the first packet. The remaining lines 2105 indicate three possibilities for a spread picture start code. One might expect that it is impossible to detect a partially encrypted picture start code. However, there is a way out of this dilemma. Each plaintext area contains a picture start code or at least the last byte of it. So if no picture start-code is found in a plaintext area it is known that this area must start with some of the last bytes of the picture start code. This number of bytes can be one, two or three as shown in FIG. 21. It may be possible to detect exactly how many bytes there are. In this respect, it is noted that the three bits of the picture coding type can never be all zero because this is forbidden by the implemented standard. Therefore, the second byte after the picture start code indicated by 0xYY in FIG. 21 can never be 0x00. So if the plaintext area starts with 0x00 0x01 0x00, these must be the last three bytes of the picture start code. If it starts with 0x01 0x00, these are the last two bytes. If it starts with 0x00 but not with 0x00 0x01 0x00, there is only the last byte. In this way it is exactly known where the picture start code is located and the data following it can be parsed. The picture type can be read from byte 0xYY if needed.

One could also say that it is impossible to clean up the last packet of an I-frame by removing all non I-frame data if the picture start code is spread over two packets. This is in fact correct because the encrypted part of the picture start code is not removed. But in the trick-play stream construction, an empty P-frame will be appended to the end of the I-frame. This empty P-frame will start with a picture start code. So the encrypted bytes of the picture start code can be reused because it is known how many of these bytes there are at the end of the last encrypted packet. This number of bytes is removed from the picture start code of the first empty P-frame to be added after the I-frame.

FIG. 22 shows an example of such a situation and particularly shows a picture start code 2200, a temporal reference 2201, a picture coding type 2202 and empty frame data 2203.

Inserted empty P-frame data have to be in plaintext in the absence of a DVB encrypter in the storage device. The situations that are to be expected in practice are described above, but in theory some additional situations can occur. This originates from the fact that the plaintext PES header area and the plaintext area resulting from criteria 2 and 3 in theory need not be connected but can be separated by encrypted video packets. For clarity it is mentioned that a contiguous plaintext area means that a sequence of video packets is in plaintext but that other encrypted packets can be in between.

In line with the criteria, there are three important data areas that may have to be accessed:

1. The PES header information.

2. The information in the sequence header and sequence extension.

3. The information from picture start-code to picture coding extension.

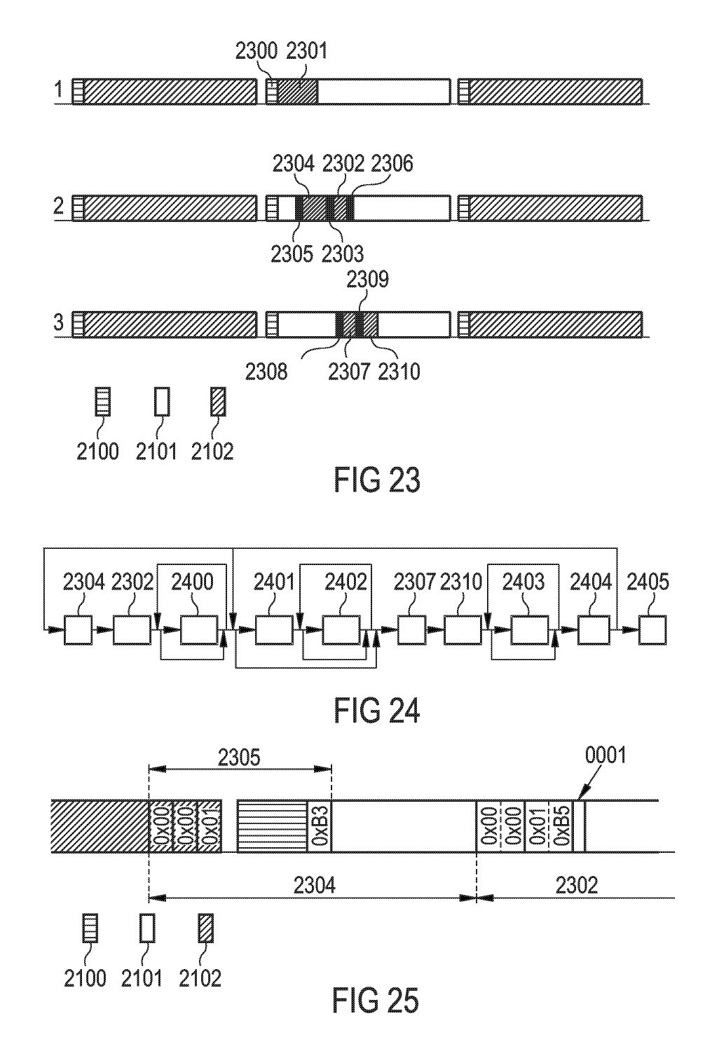

These three data areas are depicted in FIG. 23.

FIG. 23 shows plaintext data areas corresponding to the three above-mentioned points. Concerning the first point, a PLUSI 2300 (payload unit start indicator) and a PES header 2301 are shown.

According to the second point, a sequence extension 2302, a sequence extension code 2303, a sequence header 2304 and a sequence header code 2305 are shown as well as a picture start code 2306.

Referring to the third point, a picture start code 2308 and a picture header 2307 are shown as well as a picture coding extension code 2309 and a picture coding extension 2310.

Three items should be found in the stream in order to locate and correctly parse this data:

1. The PLUSI bit 2300 in the packet header.

2. The sequence header code 2305 (0x00 0x00 0x01 0xB3).

3. The picture start-code 2308 (0x00 0x00 0x01 0x00).

Finding item 1 is easy, since it is sufficient to just look for the PLUSI bit 2300 in the packet header, and if it is set to “1”, the packet will start with the PES header 2301, which can then be parsed.

The situation for items 2 and 3 may be more complicated, because the sequence header code 2305 and the picture start code 2308 can be spread over two packets resulting in partly encrypted codes. Therefore, a direct detection of these codes would lead to some loss of data. There is however a solution for this problem. In MPEG2, the presence of sequence extension 2302 and picture coding extension 2310 is mandatory, as is depicted in FIG. 24.

FIG. 24 shows a sequence header 2304 coupled with the sequence extension 2302 which are provided to extension and user data 2400. Further, extension and user data 2400 is coupled with a group of pictures header 2401 that is coupled to a user data 2402. The user data 2402 is coupled to a picture header 2307 that is coupled to a picture coding extension 2310. This picture coding extension 2310 is coupled with the user data 2403, and the user data 2403 is coupled with picture data 2404. Then, a sequence end 2405 is reached.

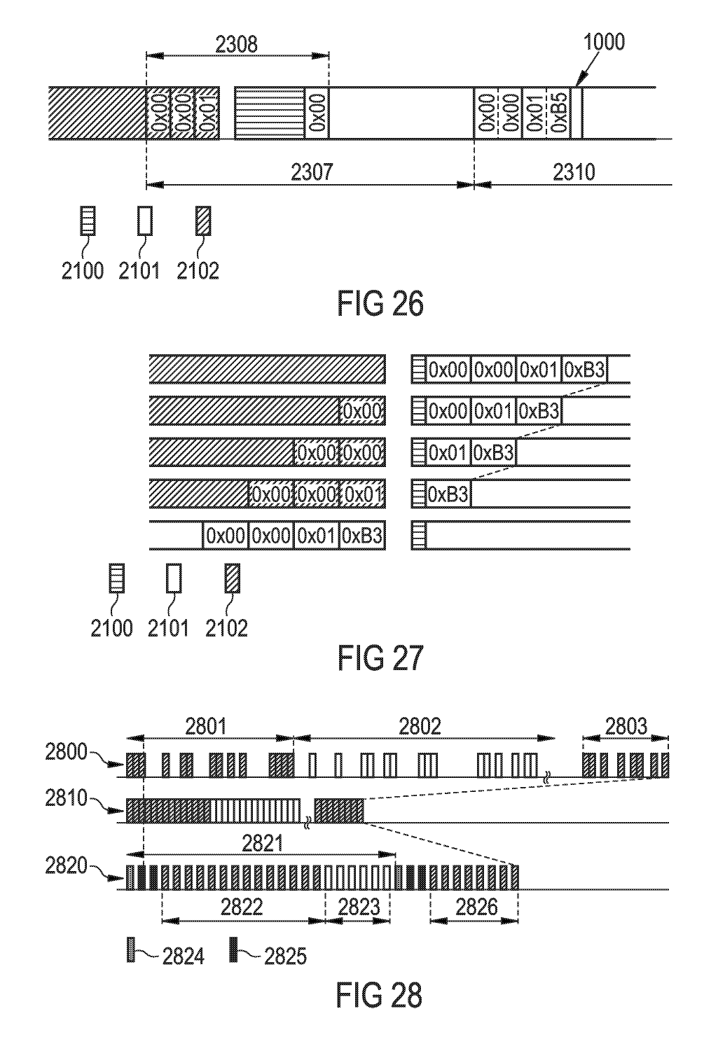

The way the criteria for plaintext packets are formulated guarantees that these extensions will be fully in plaintext. They can be found by first searching for the extension start code being 0x00 0x00 0x01 0xB5. The next four bits are the extension start code identifier. These four bits are 0001 for the sequence extension and 1000 for the picture coding extension. If a sequence extension is present, the sequence header code must also be present and identically if a picture coding extension is present the picture start code must also be present. This leads to the following:
If a sequence extension 2302 is found in a plaintext area and the sequence header code 2304 is not detected in this same area, then the sequence header code 2304 must be spread over two packets, and the last byte(s) of the sequence header code 2304 are the first bytes of this plaintext area disregarding a possible PES header (see FIG. 25).
If a picture coding extension 2310 is found in a plaintext area and the picture start code 2308 is not detected in this same area, then the picture start code 2308 must be spread over two packets, and the last byte(s) of the picture start code 2308 are the first bytes of this plaintext area disregarding a possible PES header (see FIG. 26).

It should be noticed that these two situations can never occur simultaneously in one plaintext area. If sequence extension 2302 and picture coding extension 2310 are both present, the picture start code 2308 that is located between these two will inevitably be fully in plaintext. Only the sequence header code 2305 can be partially encrypted in this case. Of course, if a sequence header code 2305 or picture start-code 2308 is fully in plaintext and therefore detected in a straightforward manner, the parsing of the corresponding data can start immediately. However, if one of the above situations is encountered, it must first be known how many bytes of these codes are at the start of the plaintext area or after the PES header before a correct parsing can start. The method to detect this for the picture start code 2308 has been described earlier. The same method can also be applied for the sequence header code 2305.

The situation for the sequence header code 2305 is depicted in FIG. 27.

The plaintext is only guaranteed from the fourth byte onwards. This byte is the last byte of the sequence header code 2305 that equals 0x00 0x00 0x01 0xB3. So if a sequence header code 2305 is present but not detected in this area, some of its last bytes must be present at the start of this area or after the PES header. As with the picture start code 2308 it is possible to detect exactly how many of these bytes there are. Detection will start at the first plaintext byte in the area disregarding the PES header. If the first bytes are 0x00 0x01 0xB3, there are three bytes, if they are 0x01 0xB3, there are two bytes and if the first byte is 0xB3, there is only this one byte. Knowing the number of bytes and therefore the location of the last byte of the sequence header code 2305 or picture start code 2308 enables a correct parsing of the data following this code.

In the following, stream construction on transport stream level will be explained.

In this context, packet positioning will first be described.

The position of the packets copied to the trick-play stream can usually not be coupled to the relative timing of the original transport stream, due to the compression and possible inversion (reverse mode) of the time axis in trick-play. Therefore, the pre-pended packet arrival time stamps of the original packet arrival time stamped transport stream are usually not usable for trick-play generation. This is a reason why the described trick-play method can also be used for transport streams without pre-pended packet arrival time stamps. Because the original relative timing is not used, another timing mechanism has to be chosen. As will become clear later, a proper way to do this is to smooth the packet rate over a trick-play GOP, as is depicted in FIG. 28.

FIG. 28 schematically illustrates packet smoothing for trick-play.

As can be seen, a broadcast stream 2800 includes I-frame data 2801, P-/B-frame data 2802 and further I-frame data 2803. The I-frame data 2801 is not provided equidistantly, but comprises a plurality of packets distributed in a non-ordered manner in the time domain, as can be seen in the upper row 2800 of FIG. 28.

The data format as stored on hard disk is shown in row 2810 of FIG. 28. Here, the various single packets of the I-frame data 2801 are provided one after the other without a distance in between, as well as the P-/B-frame data 2802 and the further I-frame data 2803.

A trick-play output 2820 is further illustrated in FIG. 28 showing a PCR packet 2824 (Program Clock Reference) followed by PAT (Program Association Table) and PMT (Program Map Table) packets 2825. Then, the sequence of packets of the I-frame data 2801 are provided in a smoothed manner as smoothed I-frame data 2822, followed by smoothed empty P-frame data 2823. However, smoothed empty B-frames are also possible additionally or alternatively. Subsequently, a further PCR packet 2824 and two PAT, PMT packets 2825 are provided followed by smoothed further I-frame data 2826. The smoothed I-frame data 2822 and empty P-frame data 2823 are spaced in the time domain by a nominal GOP time T/R 2821.

The number of packets for the I-frame 2822 is known, as it is for the empty P-frames 2823 and some additional packets (e.g. PCR, ECM, SIT, DIT, etc.). The total of the packets is transmitted in the nominal GOP time 2821 that is equal to l/Rₜ or T/R. The packet distance is calculated from the number of packets and the GOP time 2821. In fact, the calculated packet transmission moment may be translated into new packet arrival time stamps that are pre-pended to the trick-play packets. These packet arrival time stamps may be derived from the calculated value of the new PCR trick-play time base at the start of the packet. In this way, the generated trick-play stream 2820 may be handled by the same output circuitry as may be used for normal play. The new PCR trick-play time base will be discussed hereafter.

In the following, aspects related to Program Clock Reference (PCR) will be described.

The original PCR time base can usually not be used for trick-play. First of all, it is probable but not guaranteed that a PCR will be present within the selected I-frame. More importantly, the frequency of the PCR time base is no longer correct. This frequency should be within 30 ppm from 27 MHz but is now multiplied by the trick-play speed factor, even leading to a time base running in the wrong direction for reverse trick-play.

Thus, the old PCR time base has to be removed and a new one has to be added. Old PCRs are removed by cleaning the adaptation fields in which they are located. Adaptation fields are not encrypted. The new PCRs are added by placing an additional PCR packet 2824 at the start of each trick-play GOP 2821, as indicated in FIG. 28. Since these GOPs are transmitted exactly in the nominal GOP time 2821, the distance between PCR values is constant and can be derived from this nominal GOP time 2821. As a result, the addition of a new PCR time base with high timing accuracy is very simple.

The PCR 2824 is composed of two parts, namely PCR base and PCR extension. The latter is the LSB part of 9 bits and may range from 0 to 299. The PCR base is the MSB part with a size of 33 bits and a full range. The frequency of the PCR base is 27 MHz/300=90 kHz. Almost all frame rates fit to this 90 kHz. For these rates, the PCR extension is constant for points that are an integer multiple of the frame time apart. Because the nominal GOP time 2821 is such an integer multiple, the PCR extension of all inserted PCRs of the new time base can be set to zero. Only the eccentric rates of 23.976 Hz and 59.94 Hz do not fit to the 90 KHz. However, for 59.94 Hz, the PCR extension is constant for a distance equal to an even multiple of the frame time, and in the case of 23.976 Hz for a fourfold frame time. With the IPPP (T=4) trick-play GOP structure, a fixed value of zero for the PCR extension can be used for all frame rates, further simplifying the insertion of a new PCR time base.

The distance between subsequent PCRs 2824 in the transmitted stream, according to the MPEG2 standard, should not exceed 100 ms. In the DVB standard, this value is even lower, namely 40 ms. Sending only one PCR 2824, every trick-play GOP 2821 clearly violates these limits. In a worst-case situation with T=4 and R=25 Hz, the distance between PCRs 2824 is 160 ms. In experiments, no problems were experienced with violating this distance. Additional PCRs 2824 could be included in the stream, but this is more complex and does not seem to be necessary in all cases.

In the following, aspects related to Decoding Time Stamp (DTS) and Presentation Time Stamp (PTS) will be discussed.

Frames can contain two time stamps, which may tell a decoder when to start decoding the frame (DTS) and when to start presenting (for instance displaying) it (PTS). They are started when DTS, respectively PTS, are equal to the PCR time base, which is reconstructed in the decoder by means of the PCRs in the stream. Since a new PCR time base is added to the trick-play stream and because the time distances for the DTS and PTS are no longer correct anyway, the DTS and PTS of the I-frame may be replaced, if present. DTS and PTS are located in the PES header.

At least two ways exist to construct a trick-play GOP, namely with one PES packet per frame or one per GOP. In the case of a partly encrypted picture start-code, one PES packet per frame can in fact not be used. So one PES packet per GOP may be chosen even if the original stream was one PES packet per frame. Therefore, the inserted empty P-frames have no DTS or PTS. The PES packet length is set to zero (unbounded) whatever its original value.

It should be considered when the decoding of the I-frame could start. The packets of the trick-play GOP are spread out over the constant GOP time. Almost all of the trick-play GOP is related to I-frame data, so the end of the I-frame is close to the start of the next GOP. Therefore, the decoding of the I-frame can start at the beginning of the next GOP. So the DTS of the I-frame is set to a value corresponding to the PCR time base at the start of the next GOP. The DTS and PTS usually only contain a reference to the PCR base. The DTS is therefore identical to the PCR base that will be inserted at the start of the next GOP.

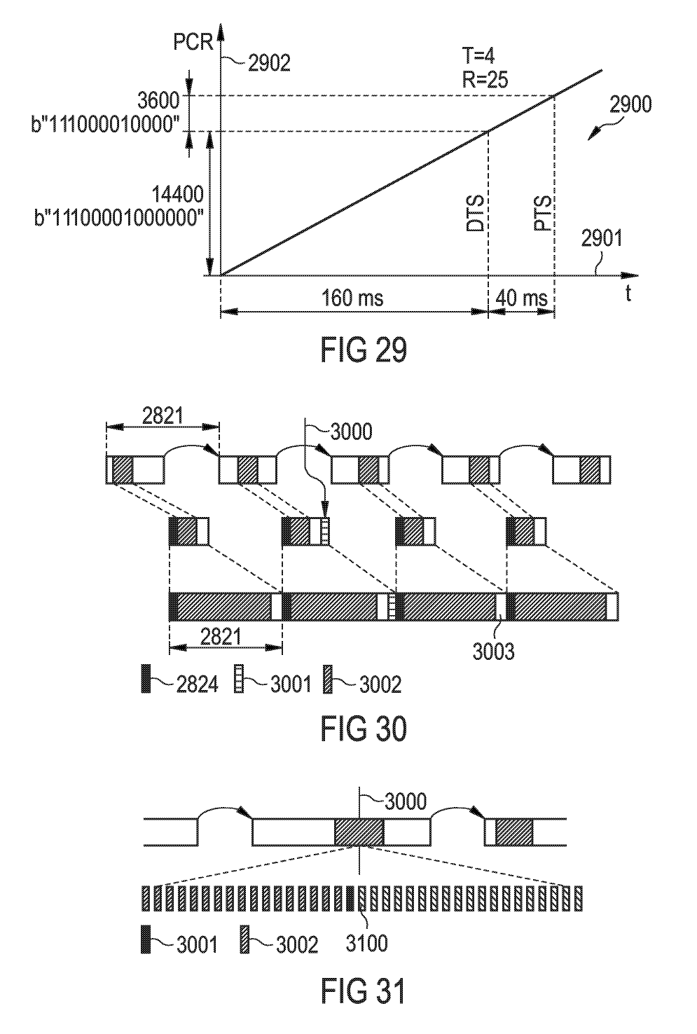

It should further be considered when the presentation of the I-frame could start. A time of one frame between DTS and PTS is not only appropriate for a stream with only I-frames and P-frames, but is what the MPEG2 standard prescribes for such a stream if the low_delay_flag is not set. So the PTS of the I-frame is set to the DTS value plus a value corresponding to one frame time. For the frame rates of 23.976 Hz and 59.94 Hz, this is a value near to one frame time. The PCR distance between the start of successive trick-play GOPs is already calculated. This distance has a precision equal to the PCR base and therefore equal to the DTS and PTS. The offset value between PTS and DTS can be calculated by dividing the PCR distance by the trick-play GOP size T. This is in fact very simple in the case of an IPPP (T=4) structure where it is necessary to divide by 4. The bits of the PCR distance are simply shifted by two places to calculate the PTS/DTS offset. This is depicted in FIG. 29.

FIG. 29 shows a diagram 2900 wherein the time t is plotted along an abscissa 2901, and the PCR base is plotted along an ordinate 2902. FIG. 29 relates to a GOP size of T=4 and a Refresh Rate of R=25.

In the following, some aspects related to the insertion of ECMs (Entitlement Control Messages) will be discussed.

In the case of an encrypted trick-play stream, ECMs have to be present in this stream to enable the decryption by the receiver (for example an STB). In this context, it should be decided when ECMs have to be inserted and where. In a preferred case, where the recorded stream already contains the necessary plaintext packets, the data block read from the storage device will only contain I-frame data. The ECM insertion method should however also allow for the more general case with larger block sizes.

The first I-frame of the data block is used to construct a trick-play GOP. Most ECMs will have to be sent somewhere between these I-frames, which is in fact between two trick-play GOPs. As previously described, all trick-play GOPs may have an equal length in time and the packets of a GOP may be spread out over this time to smooth the bit rate. Inserting ECMs between these GOPs would unnecessarily increase the local bit rate. It may be better to embed the ECM in a trick-play GOP. Then, it has to be decided to which GOP the ECM is added. There are particularly the following two options:

1. An ECM may be added to the end of the previous trick-play GOP.

2. An ECM may be added to the start of the next trick-play GOP.

In the second option, the ECM is not really the first packet of the next GOP, because these are the inserted PCRs that must remain in that position for timing reasons. So the ECM is the second packet in this case. Although in practice, the difference between the two options may be negligible in many cases, the optimal position is given by option 1 because it maximizes the available time for the decryption of the ECM.

This situation is depicted in FIG. 30.

FIG. 30 shows, in addition to already introduced components, an SCB toggle 3000, an ECM packet 3001 and I-frame data 3002. Furthermore, empty P frames 3003 are illustrated in FIG. 30.

With forward trick-play, it can also occur sometimes that the SCB toggle 3000 is not located between the I-frames but somewhere within the selected I-frame. An ECM 3001 has to be sent when the SCB toggle 3000 is crossed. This means that in this case the ECM 3001 should be inserted at the correct location within the I-frame. Again, there are in particular two options to do this:

1. ECM 3001 may be inserted before the I-frame packet with the SCB toggle 3000.

2. ECM 3001 may be inserted after the I-frame packet with the SCB toggle 3000.

The packet with the SCB toggle 3000 is the encrypted video packet with an SCB value other than the preceding encrypted video packet. In some cases, it does not really matter whether option 1 or 2 is used, but in theory the best position is usually before the packet with the SCB toggle 3000. This is because on the one hand the CW of the previous period is no longer needed from this moment on, and on the other hand, the time to decrypt the ECM 3001 is maximized.

Option 1 is depicted in FIG. 31. Particularly, a packet 3100 with SCB toggle is shown in FIG. 31.

In all cases, the PID number and table ID of the inserted ECMs are preferably the original ones to enable a smooth switching between normal play and trick-play in both directions. The continuity counter in the ECM packet header may be corrected though.

In the following, some aspects will be discussed as to where to make or generate the hybrid stream.

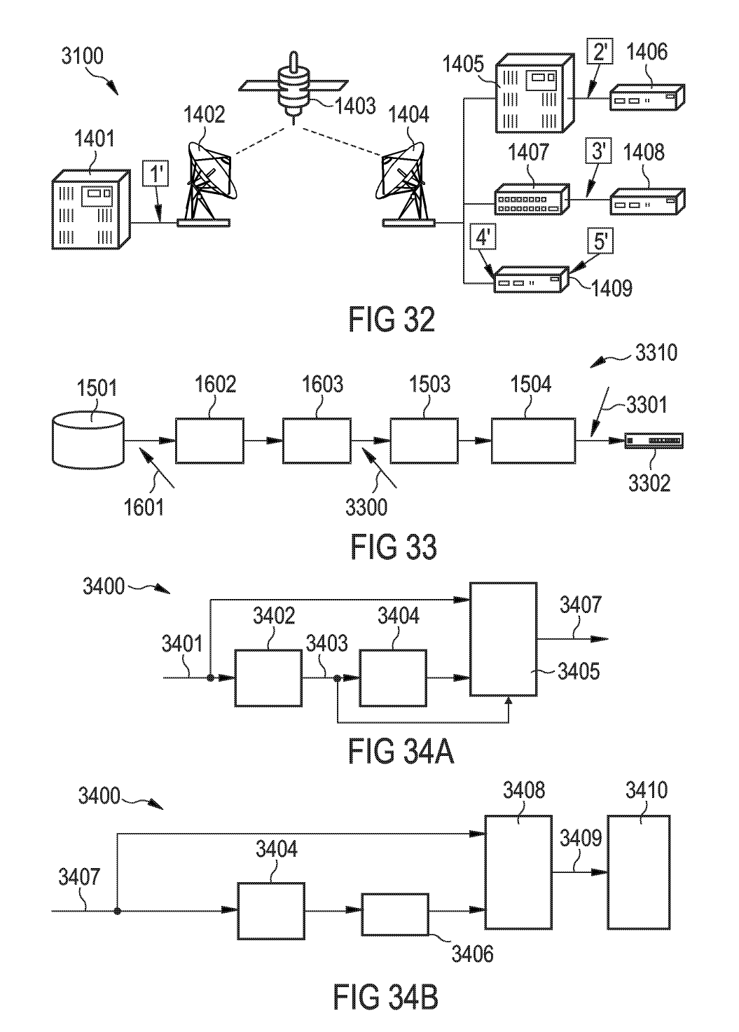

The hybrid stream described herein can be created in several places. In this context, reference is made to FIG. 32.

The possible places are in fact the same locations as for a stream with plaintext I-frames (see FIG. 14 and corresponding description):

1′. At the broadcaster 1401 or uplink in the case of satellite broadcast.

2′. At the cable head-end 1405 in the case of a cable network.

3′. At the residential gateway 1407 in the case of a secure authorized domain.

4′. At the recording side of the storage device 1409.

However, for a stream with only a few plaintext packets, a fifth location should be added:

5′. At the playback side of the storage device 1406, 1408, 1409.

The possible locations 1′ to 5′ are visualized in FIG. 32.

Locations 1′ and 2′ might be difficult to realize because there is only a limited influence there. For the storage device, it makes in fact no difference whether the transformation to a hybrid stream is realized in locations 1′, 2′ or 3′. So option 3′ may be a very good choice. In all three cases, the storage device may receive a hybrid stream at its recording input. This means that no decryption and smart card are necessary in the storage device, at least not for normal play and the trick-play generation. But decryption may still be necessary if a metadata extraction function is present inside the storage device that uses the detection of key frames, etc. An appropriate location to construct the hybrid stream might be case 4′, which is at the recording side of the storage device. Although this asks for a partial decryption at the recording side, it still has the advantage that no decryption is needed for trick-play generation. Anyway, it is preferred that the recorded stream is a hybrid one. In case 5′, where the recording is made with all packets encrypted, it is still possible to create secured trick-play as described herein. In FIG. 16, the basic approach to deal with a fully encrypted stream was shown. But instead of a full decryption, it is possible to decrypt only those packets needed, and leave the rest still encrypted (see FIG. 33).

FIG. 33 shows a system 3310 which differs from the system 1600 in that the decrypter 1603 outputs partially encrypted MPEG2 data 3300, and that the MPEG2 decoder 1506 is replaced by an MPEG2 decoder and decrypter 3302 which receives an MPEG2 compliant transport stream partially decrypted 3301. It is still possible to create a predominantly encrypted trick-play stream.

In the following, referring to FIG. 34A and FIG. 34B, a device 3400 for processing an encrypted data stream 3401 according to an exemplary embodiment of the invention will be described.

Particularly, FIG. 34A illustrates a hybrid stream generation block diagram of the device 3400. FIG. 34B illustrates a trick-play stream generation block diagram, which may be used together with the hybrid stream generation block diagram of FIG. 34A, of the device 3400.

The device 3400 comprises a decrypting unit 3402 that generates a decrypted data stream 3403 from the encrypted data stream 3401.

Further, the device 3400 includes a detecting unit 3404 that is detecting position information of I-frames in the decrypted data stream 3403. Particularly, the detecting unit 3404 detects, as the position information, a start position and an end position of each of the I-frames included in the decrypted data stream 3403.

Moreover, the device 3400 includes a replacement unit 3405 which replaces, based on the position information detected by the detecting unit 3404, portions of the encrypted data stream 3401 provided at a first input of the replacement unit 3405 by corresponding portions of the decrypted data stream 3403 provided at a second input of the replacement unit 3405. In other words, the replacement unit 3405 replaces portions of the encrypted data stream 3401 by corresponding portions of the decrypted data stream 3403 at the detected start position and end position of the I-frames. Consequently, a hybrid data stream 3407 is generated at an output of the replacement unit 3405 of the hybrid stream generation block diagram of FIG. 34A.

The hybrid data stream 3407 provided at an output of the system of FIG. 34A may be connected to an input of the system of FIG. 34B. However, storage of the hybrid data may be involved optionally.

The trick-play generator unit of FIG. 34B may optionally include a (further) detection unit 3404.

The hybrid data stream 3407 may be supplied to a trick-play generation unit 3408 for generating a data stream 3409 for reproduction in a trick-play reproduction mode, and may be supplied to the further detection unit 3404. Further, an adding unit 3406 is shown which is provided with an output of the further detection unit 3404. The adding unit 3406 may add timing information to the data stream. The data added by the adding unit 3406 is in plaintext. An output of the adding unit may be provided to the trick-play generation unit 3408.

The trick-play generation unit 3408 generates, based on its inputs, the data stream 3409 for reproduction in a trick-play reproduction mode.

This trick-play stream 3409 is provided to a reproduction unit 3410.

The adding unit 3406 may also add tables, ECM data and/or empty frames.

The generation unit 3408 may take care of re-multiplexing, timing issues, smoothing of re-multiplexed packets and/or cleaning up frame packets.

The detection unit(s) 3404 may detect frame boundaries within the decrypted stream 3403 or the hybrid stream 3407. Such frame boundaries may be frame boundaries of I-frames, B-frames and/or P-frames.

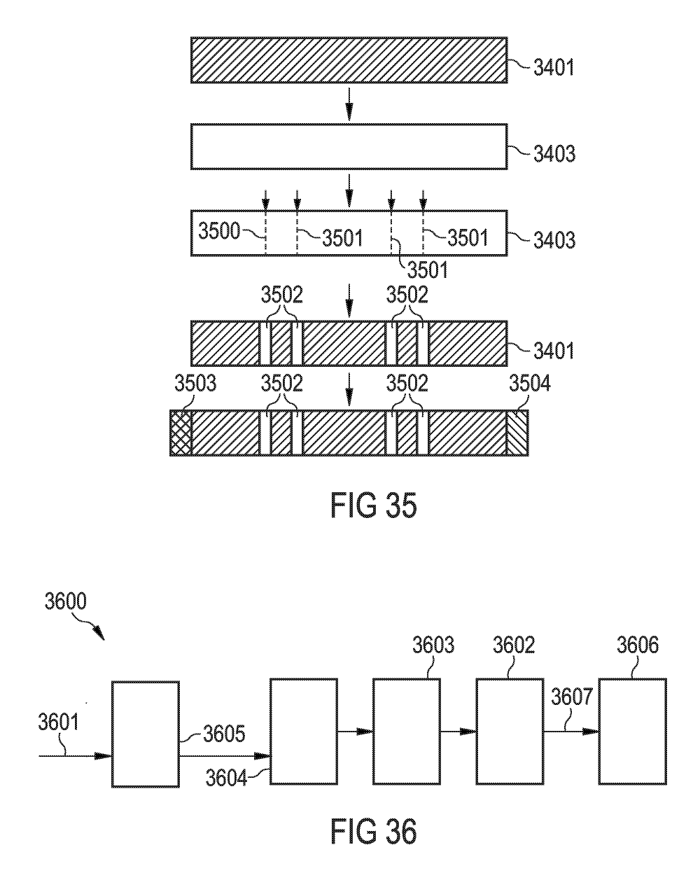

The situation of FIG. 34A, FIG. 34B is further described referring to FIG. 35 showing different data streams.

In FIG. 35, the encrypted data stream 3401 is shown. After having passed the decryption unit 3402, the completely decrypted data stream 3403 is generated. FIG. 35 further illustrates start positions 3500 and end positions 3501 detected within the decrypted data stream 3403 detected by the detection unit 3404. After having passed the replacement unit 3405, portions related to the start positions 3500 and to the end positions 3501 of the encrypted data stream 3401 are replaced by decrypted portions 3502. The adding unit 3406 adds timing information 3503 at a beginning of the stream.

Furthermore, as shown in FIG. 35, ECM information (Entitlement Control Messages) may be added at an end portion of the data stream and is denoted with reference numeral 3504.

It is noted that, additionally or alternatively to the detection of I-frame boundaries, it is also possible to detect of boundaries (that is start and/or end positions) of B-frames and/or of P-frames.

In the following, referring to FIG. 36, a device 3600 for processing a data stream 3601 having a sequence of packets and timing information related to the packets according to another exemplary embodiment of the invention will be described.

The device 3600 comprises a distribution unit 3602 for uniformly or homogeneously distributing the packets over the data stream 3601. This distribution unit 3602 which may also be denoted as a smoothing unit generates equidistantly arranged portions of I-frames as shown in the third row of FIG. 28.

A replacement unit 3603 replaces the timing information of the data stream that is no longer valid by modified timing information adjusted to the uniform distribution of the packets.

Further, a decryption-information inserting unit 3604 is provided which inserts Entitlement Control Messages (ECM) as decryption information in the data stream.

Moreover, a trick-play generation unit 3605 is provided which generates a data stream for reproduction in a trick-play reproduction mode. Trick-play data 3607 is provided to a reproduction unit 3606 for reproduction.

It is noted that the arrangement of the components of FIG. 36 may be modified. For instance, the positions of the replacement unit 3603 and of the distribution unit 3602 may be exchanged.

In the following, the signal flow path of FIG. 36 will be described.

The trick-play generation unit 3605 is provided with the data stream 3601. An output of the trick-play generation unit 3605 is coupled to an input of the decryption-information inserting unit 3604. An output of the decryption-information inserting unit 3604 is coupled to an input of the replacement unit 3603. An output of the replacement unit 3603 is coupled to an input of the distribution unit 3602. An output of the distribution unit 3602 (at which the trick-play data 3607 are provided) is coupled to an input of the reproduction unit 3606.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1-36. (canceled)

37. A device (3400) for processing an encrypted data stream (3401), wherein the device (3400) comprises
a decrypting unit (3402) for generating a decrypted data stream (3403) from the encrypted data stream (3401);
a detecting unit (3404) for detecting position information of at least one intra-coded frame in the decrypted data stream (3403); the detection unit (3404) being adapted to detect, as position information, a start position (3500) and an end position (3501) of the at least one intra-coded frame in the decrypted data stream (3403);
a replacement unit (3405) for replacing, based on the detected position information, portions of the encrypted data stream (3401) by corresponding portions of the decrypted data stream (3403); the replacement unit (3405) being adapted to replace portions of the encrypted data stream (3401) by corresponding portions of the decrypted data stream (3403) at the detected start position (3500) and end position (3501) of the at least one intra-coded frame.

38. The device (3400) according to claim 37,
wherein the detecting unit (3404) is adapted for detecting position information of at least one forward predictive frame and/or of at least one bi-directional predictive frame in the decrypted data stream (3403).

39. The device (3400) according to claim 37,
adapted to record a hybrid stream.

40. The device (3400) according to claim 37,
comprising an adding unit (3406) adapted to add timing information to a data stream which has already been processed before by the replacement unit (3405), the timing information including a reference to a position of at least one intra-coded frame.

41. The device (3400) according to claim 40,
wherein the adding unit (3406) is adapted to add the timing information in plaintext.

42. The device (3400) according to claim 37,
wherein the replacement unit (3405) is adapted to replace an amount of data of the encrypted data stream (3401) by corresponding portions of the decrypted data stream (3403) which amount is minimally required for generating a data stream (3409) for reproducing in a trick-play reproduction mode.

43. The device (3400) according to claim 37,
wherein the replacement unit (3405) is adapted in such a manner that data between a start position (3500) and an end position (3501) of the at least one intra-coded frame is free from being replaced by corresponding portions of the decrypted data stream (3403).

44. The device (3400) according to claim 37,
wherein the replacement unit (3405) is adapted to replace a packetized elementary stream packet length indicator, a presentation time stamp and/or a decoding time stamp in a header unit of the encrypted data stream (3401).

45. The device (3400) according to claim 37,
adapted to process an encrypted data stream (3401) of video data or audio data.

46. The device (3400) according to claim 37,
adapted to process an encrypted data stream (3401) of digital data.

47. The device (3400) according to claim 37,
comprising a trick-play generation unit (3408) adapted to generate a data stream (3409) for reproduction in a trick-play reproduction mode based on an output of the replacement unit (3405).

48. The device (3400) according to claim 47,
wherein the trick-play reproduction mode is one of the group consisting of a fast forward reproduction mode, a fast reverse reproduction mode, a slow motion reproduction mode, a freeze frame reproduction mode, an instant replay reproduction mode, and a reverse reproduction mode.

49. The device (3400) according to claim 37,
adapted to process an encrypted MPEG2 data stream.

50. The device (3400) according to claim 37,
realized as at least one of the group consisting of a digital video recording device and a network-enabled device and a conditional access system and a portable audio player and a portable video player and a mobile phone and a DVD player and a CD player a harddisk-based media player and an internet radio device and a public entertainment device and an MP3 player.

51. A method of processing an encrypted data stream (3401),
wherein the method comprises the steps of generating a decrypted data stream (3403) from the encrypted data stream (3401) detecting a start position (3500) and an end position (3501) of at least one intra-coded frame in the decrypted data stream (3401) replacing, at the detected start position (3500) and end position (3501) of the at least one intra-coded frame, portions of the encrypted data stream (3401) by corresponding portions of the decrypted data stream (3403).

52. A computer-readable medium, in which a computer program of processing an encrypted data stream (3401), is stored, which computer program, when being executed by a processor, is adapted to control or carry out the following method steps:
generating a decrypted data stream (3403) from the encrypted data stream (3401);
detecting a start position (3500) and an end position (3501) of at least one intra-coded frame in the decrypted data stream (3403);
replacing, at the detected start position (3500) and end position (3501) of the at least one intra-coded frame, portions of the encrypted data stream (3401) by corresponding portions of the decrypted data stream (3403).

53. A program element of processing an encrypted data stream (3401), which program element, when being executed by a processor, is adapted to control or carry out the method steps of:
generating a decrypted data stream (3403) from the encrypted data stream (3401);
detecting a start position (3500) and an end position (3501) of at least one intra-coded frame in the decrypted data stream (3403);
replacing, at the detected start position (3500) and end position (3501) of the at least one intra-coded frame, portions of the encrypted data stream (3401) by corresponding portions of the decrypted data stream (3403).

54. A device (3600) for processing a data stream (3601) having a sequence of packets and timing information related to the packets,
wherein the device (3600) comprises
a distribution unit (3602) for uniformly distributing the packets over the data stream (3601), the distribution unit (3602) being adapted to uniformly distribute packets related to a portion of the data stream (3601) between two subsequent intra-coded frames;
a replacement unit (3603) for replacing the timing information of the data stream (3601) by modified timing information adjusted to the uniform distribution of the packets, the replacement unit (3603) being adapted to arrange the modified timing information at a starting position of the processed data stream.

55. The device (3600) according to claim 54,
wherein the replacement unit (3603) is adapted to generate a Program Clock Reference, a Decoding Time Stamp and/or a Presentation Time Stamp as the modified timing information.

56. The device (3600) according to claim 54,
adapted to process an encrypted data stream (3601),
wherein the device (3600) comprises a decryption information inserting unit (3604) adapted to insert decryption information in the processed data stream.

57. The device (3600) according to claim 56,
wherein the decryption information inserting unit (3604) is adapted to insert Entitlement Control Messages as the decryption information.

58. The device (3600) according to claim 56,
wherein the decryption information inserting unit (3604) is adapted to insert the decryption information at an end of the processed data stream.

59. The device (3600) according to claim 54,
adapted to process a data stream (3601) of video data or audio data.

60. The device (3600) according to claim 54,
adapted to process a data stream (3601) of digital data.

61. The device (3600) according to claim 54,
comprising a trick-play generation unit (3605) adapted to generate a data stream (3607) for reproduction in a trick-play reproduction mode.

62. The device (3600) according to claim 61,
adapted to generate the data stream (3607) for reproduction in the trick-play reproduction mode in such a manner that different Groups of Pictures of the generated data stream have an essentially constant length in time.

63. The device (3600) according to claim 61,
wherein the trick-play reproduction mode is one of the group consisting of a fast forward reproduction mode, a fast reverse reproduction mode, a slow motion reproduction mode, a freeze frame reproduction mode, an instant replay reproduction mode, and a reverse reproduction mode.

64. The device (3600) according to claim 54,
adapted to process an encrypted MPEG2 data stream.

65. The device (3600) according to claim 54,
realized as at least one of the group consisting of a digital video recording device and a network-enabled device and a conditional access system and a portable audio player and a portable video player and a mobile phone and a DVD player and a CD player a harddisk-based media player and an internet radio device and a public entertainment device and an MP3 player.

66. A method of processing a data stream (3601) having a sequence of packets and timing information related to the packets,
wherein the method comprises the steps of
uniformly distributing packets related to a portion of the data stream (3601) between two subsequent intra-coded frames;
replacing the timing information of the data stream (3601) by modified timing information arranged at a starting position of the processed data stream.

67. A computer-readable medium, in which a computer program of processing a data stream (3601) having a sequence of packets and timing information related to the packets, is stored, which computer program, when being executed by a processor, is adapted to control or carry out the following method steps:
uniformly distributing packets related to a portion of the data stream (3601) between two subsequent intra-coded frames;
replacing the timing information of the data stream (3601) by modified timing information arranged at a starting position of the processed data stream.

68. A program element of processing a data stream (3601) having a sequence of packets and timing information related to the packets, which program element, when being executed by a processor, is adapted to control or carry out the method steps of:
uniformly distributing packets related to a portion of the data stream (3601) between two subsequent intra-coded frames;
replacing the timing information of the data stream (3601) by modified timing information arranged at a starting position of the processed data stream.
